(19) United States
(12) Patent Application Publication
(10) Pub. No.: US 2026/0015289 A1
(43) Pub. Date: Jan. 15, 2026

(54) METHOD AND COMPOSITION FOR PRODUCING COLOR UNIFORM SINTERED CERAMIC BODIES

(71) Applicant: James R. Glidewell Dental Ceramics, Inc., Newport Beach, CA (US)

(72) Inventors: Andrew Schissler, Garden Grove, CA (US); Sreeram Balasubramanian, Irvine, CA (US); Dimple Pradhan, Foothill Ranch, CA (US); Yan Yang, Lake Forest, CA (US)

(73) Assignee: James R. Glidewell Dental Ceramics, Inc., Newport Beach, CA (US)

(21) Appl. No.: 19/266,576

(22) Filed: Jul. 11, 2025

Related U.S. Application Data
(60) Provisional application No. 63/670,529, filed on Jul. 12, 2024.

(51) Int. Cl. C04B 35/48; C04B 35/626; C04B 35/64

(52) U.S. Cl. CPC C04B 35/48; C04B 35/62625; C04B 35/64; C04B 2235/3225; C04B 2235/3246; C04B 2235/3262; C04B 2235/3272; C04B 2235/3275; C04B 2235/6027; C04B 2235/604; C04B 2235/6565; C04B 2235/6567; C04B 2235/9661

(57) ABSTRACT

Disclosed herein are aspects of materials comprising a color uniform sintered ceramic comprising iron (III) oxide (Fe₂O₃) and yttria-stabilized zirconia. Also disclosed herein are aspects of a method of forming the sintered ceramic body. A method for making sintered ceramic bodies comprising introducing an iron-containing, yttria-stabilized zirconia ceramic material into a furnace; heating the ceramic material in the furnace to a furnace temperature ranging from 1200° C. to 1700° C. for at least 5 minutes; and cooling the ceramic material at a controlled furnace cooling rate ranging from greater than 0° C./minute to 3° C./minute to a temperature ranging from 800° C. to 1200° C.

### CROSS REFERENCE TO RELATED APPLICATION

This application claims the benefit of and priority to U.S. Provisional Application No. 63/670,529, filed on Jul. 12, 2024. The prior application is incorporated herein by reference in its entirety.

### FIELD

The present disclosure concerns a method and composition for producing color uniform sintered ceramic bodies comprising iron (III) oxide (Fe₂O₃).

### BACKGROUND

Iron (III) oxide (Fe₂O₃) is a common dopant in yttria-stabilized zirconia (YSZ) to impart yellow-orange color in sintered ceramic bodies. However, yttria-stabilized zirconia sintered ceramic bodies doped with Fe₂O₃, exhibit color discoloration and undesirable gray-green hues at greater depths. To address this issue, alternative dopants have been proposed to achieve the yellow hue. However, iron is the primary colorant ion in pre-colored YSZ powders on the market intended to impart a yellow hue. Therefore, there is a need in the art for new materials and methods that can utilize iron-containing pre-colored YSZ powders and mitigate color discoloration and undesirable gray-green hues.

### SUMMARY

Disclosed herein is a material, comprising: a sintered ceramic comprising iron (III) oxide (Fe₂O₃) and yttria-stabilized zirconia; a distance from a cross-sectional center comprising a core to a perimeter portion of the sintered ceramic ranging from 4 millimeters to 15 millimeters; and (i) a CIELAB a* at the core greater than −2, (ii) a first CIELAB b* at the core of less than or equal to 8 points below a second CIELAB b* at the perimeter portion of the sintered ceramic, (iii) a first CIELAB hue angle (h_{ab}) at the core of less than or equal to 5 degrees greater than a second CIELAB hue angle (h_{ab}) at the perimeter portion; (iv) or any combination of (i), (ii), and/or (iii).

Also disclosed herein is a material, comprising: a sintered ceramic comprising iron (III) oxide (Fe₂O₃) and yttria-stabilized zirconia; a minimum distance from a cross-sectional center comprising a core to a perimeter portion of the sintered ceramic ranging from 5 millimeters to 15 millimeters; and (i) a first CIELAB b* value at the core of at least 20 or greater; (ii) a CIELAB chroma (C*_{ab}) value of 20 or greater at the core; (iii) a CIELAB chroma difference (ΔC*_{ab}) between the perimeter portion and the core ranging from greater than 0 to 16; (iv) a saturation (C*ab/L*) at the core ranging from 0.25 to 0.35; or (v) or any combination of (i), (ii), (iii) and/or (iv).

A method for making a sintered ceramic body is also disclosed herein, the method comprising: introducing an iron-containing, yttria-stabilized zirconia ceramic material into a furnace; heating the ceramic material in the furnace to a furnace temperature ranging from 1200° C. to 1700° C. for at least 5 minutes; and cooling the ceramic material at a controlled furnace cooling rate ranging from greater than 0° C./minute to 3° C./minute to a temperature ranging from 800° C. to 1200° C.

The foregoing and other objects, features, and advantages of the present disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustrating a cylindrical ceramic body sectioned half length-wise (longitudinally) and at the cross-sectional center.

FIG. 2 is a schematic illustrating a rectangular ceramic body sectioned in half.

FIG. 3 is a schematic drawing illustrating a sectioned rectangular sintered ceramic block sectioned in half to expose a core, wherein the section face comprising the exposed core comprises a top portion, a mid-portion, and a bottom portion.

FIG. 4A is a line graph (temperature v. time) of the temperature profile and comparing a cylindrical sintered ceramic block comprising yttria (4 mol %) and Fe₂O₃ (0.2 wt. %) cooled at a controlled furnace cooling rate of 1° C./minute to a temperature of 900° C. (Article 2) versus a comparator cylindrical sintered ceramic block comprising yttria (4 mol %) and Fe₂O₃ (0.2 wt. %) cooled at a controlled furnace cooling rate of 11.7° C. to a temperature of 1200° C. (Comparator Article 3).

FIGS. 4B-4C are images of the skin, first core, and second core of Article 2 (FIG. 4B) comprising yttria (4 mol %) and Fe₂O₃ (0.2 wt. %) fired to a cycle with peak temperature of 1550° C. with subsequent controlled cooling at a rate of 1° C./min to 900° C. and Article 3 (FIG. 4C) comprising yttria (4 mol %) and Fe₂O₃ (0.2 wt. %) fired to a near-identical cycle as that of Article 2 and differing only in that cooling from 1550° C. was controlled at a rate of 11.7° C./min to a temperature of 1200° C.; Article 2 exhibiting a ΔE of 2.05 and Article 3 having a ΔE of 16.97; thus, this figure demonstrates that Article 2 did not exhibit gray-green core discoloration and a greater color consistency throughout the volume.

FIG. 5A is a line graph (temperature v. time) showing the temperature profile of a comparator rectangular sintered ceramic block comprising yttria (4 mol %) and Fe₂O₃ (0.2 wt. %) cooled with a controlled furnace cooling rate of 11.7° C./minute to a temperature of 1200° C. (Article 6).

FIG. 5B is a line graph (temperature v. time) showing the temperature profile of an annealed rectangular ceramic block first subjected to the temperature profile of FIG. 5A and subsequently subjected to an aspect of the method disclosed herein comprising yttria (4 mol %) and Fe₂O₃ (0.2 wt. %) cooled with a controlled furnace cooling rate of 1° C./minute to 900° C. (Article 7).

FIGS. 5C-5D are images of the skin and second core of Article 6 (FIG. 5C) and Article 7 (FIG. 5D); Article 6 exhibiting a ΔE (skin-core) of 18.10 after being fired to a cycle with cooling from 1550° C. to 1200° C. at a rate of 11.7° C./min and Article 7 exhibiting a ΔE of 1.08 after being fired to the same cycle as Article 6 and subsequently annealed at 1550° C. before cooling to 900° C. at a rate of 1° C./min; thus, this figure demonstrates that subjecting sintered ceramic blocks to a subsequent annealing cycle with controlled furnace cooling yields reduced discoloration and subsurface desaturation.

FIG. 6A is a bar graph comparing the ΔC* (skin-core) of sintered ceramic bodies comprising 4 mol % yttria with a controlled furnace cooling rate of 1° C./minute to a temperature of 900° C. of Article 46 (0.06 wt. % Fe₂O₃), Article 51 (0.06 wt. % Fe₂O₃), Article 47 (0.08 wt. % Fe₂O₃), Article 53 (0.08 wt. % Fe₂O₃), Article 56 (0.08 wt. % Fe₂O₃), Article 52 (0.1 wt. % Fe₂O₃), Article 48 (0.11 wt. % Fe₂O₃), Article 54 (0.11 wt. % Fe₂O₃), Article 49 (0.13 wt. % Fe₂O₃), Article 55 (0.14 wt. % Fe₂O₃), Article 50 (0.16 wt. % Fe₂O₃), Article 39 (0.2 wt. % Fe₂O₃) versus comparator articles comprising a controlled furnace cooling rate of 11.7° C. to a temperature of 1200° C. Comparator Article 43 (0.1 wt. % Fe₂O₃), Comparator Article 41 (0.11 wt. % Fe₂O₃), Comparator Article 44 (0.11 wt. % Fe₂O₃), Comparator Article 45 (0.12 wt. % Fe₂O₃), Comparator Article 42 (0.13 wt. % Fe₂O₃), Comparator Article 1 (0.2 wt. % Fe₂O₃); therefore, this figure shows that the articles exhibited greater consistency in C* from skin to core relative to the comparator articles.

FIG. 6B is a bar graph comparing the ΔE between the core and skin of sintered ceramic bodies comprising 4 mol % yttria with a controlled furnace cooling rate of 1° C./minute to a temperature of 900° C. of Article 46 (0.06 wt. % Fe₂O₃), Article 51 (0.06 wt. % Fe₂O₃), Article 47 (0.08 wt. % Fe₂O₃), Article 53 (0.08 wt. % Fe₂O₃), Article 56 (0.08 wt. % Fe₂O₃), Article 52 (0.1 wt. % Fe₂O₃), Article 48 (0.11 wt. % Fe₂O₃), Article 54 (0.11 wt. % Fe₂O₃), Article 49 (0.13 wt. % Fe₂O₃), Article 55 (0.14 wt. % Fe₂O₃), Article 50 (0.16 wt. % Fe₂O₃), Article 39 (0.2 wt. % Fe₂O₃) versus comparator articles comprising a controlled furnace cooling rate of 11.7° C. to a temperature of 1200° C. Comparator Article 43 (0.1 wt. % Fe₂O₃), Comparator Article 41 (0.11 wt. % Fe₂O₃), Comparator Article 44 (0.11 wt. % Fe₂O₃), Comparator Article 45 (0.12 wt. % Fe₂O₃), Comparator Article 42 (0.13 wt. % Fe₂O₃), Comparator Article 1 (0.2 wt. % Fe₂O₃); therefore, this figure demonstrates that the articles exhibit a lower ΔE whereas the comparator articles exhibited increasing ΔE (perceivable disagreement in color) between the skin and core.

FIG. 6C is an image of the skin, first core, and a second core (as illustrated by FIG. 1) of a sintered ceramic body (Article 39) cooled with a controlled furnace cooling rate of 1° C./minute to a temperature of 900° C. exhibiting a ΔE (skin-core) of 2.6 units; a ΔC* (skin-core) of 1.11 units; and showing no gray-green discoloration.

FIG. 6D is an image of the skin, first core, and second core of a sintered ceramic body (Article 46) cooled with a controlled furnace cooling rate of 1° C./minute to a temperature of 900° C. exhibiting a ΔE (skin-core) of 1.2 units; ΔC* (skin-core) of 0.46 units; and showing no gray-green discoloration.

FIG. 6E is an image of the skin, first core, and second core of a sintered ceramic body (Article 51) cooled with a controlled furnace cooling rate of 1° C./minute to a temperature of 900° C. exhibiting a ΔE (skin-core) of 2.8 units; ΔC* (skin-core) of −0.58 units; and showing no gray-green discoloration.

FIG. 6F is an image of the skin, first core, and second core of a sintered ceramic body (Article 52) cooled with a controlled furnace cooling rate of 1° C./minute to a temperature of 900° C. exhibiting a ΔE (skin-core) of 1.2 units; ΔC* (skin-core) of 0.54 units; and showing no gray-green discoloration.

FIG. 6G is an image of the skin, first core, and second core of a sintered ceramic body (Article 47) cooled with a controlled furnace cooling rate of 1° C./minute to a temperature of 900° C. exhibiting a ΔE (skin-core) of 2.3 units; ΔC* (skin-core) of 0.1 units; and showing no gray-green discoloration.

FIG. 6H is an image of the skin, first core, and second core of a sintered ceramic body (Article 48) cooled with a controlled furnace cooling rate of 1° C./minute to a temperature of 900° C. exhibiting a ΔE (skin-core) of 1.2 units; ΔC* (skin-core) of 0.56 units; and showing no gray-green discoloration.

FIG. 6I is an image of the skin, first core, and second core of a sintered ceramic body (Article 53) cooled with a controlled furnace cooling rate of 1° C./minute to a temperature of 900° C. exhibiting a ΔE (skin-core) of 2 units; ΔC* (skin-core) of 0.63 units; and showing no gray-green discoloration.

FIG. 6J is an image of the skin, first core, and second core of a sintered ceramic body (Article 54) cooled with a controlled furnace cooling rate of 1° C./minute to a temperature of 900° C. exhibiting a ΔE (skin-core) of 3 units; ΔC* (skin-core) of 1.33 units; and showing no gray-green discoloration.

FIG. 6K is an image of the skin, first core, and second core of a sintered ceramic body (Article 49) cooled with a controlled furnace cooling rate of 1° C./minute to a temperature of 900° C. exhibiting a ΔE (skin-core) of 1.5 units; ΔC* (skin-core) of 0.27 units; and showing no gray-green discoloration.

FIG. 6L is an image of the skin, first core, and second core of a sintered ceramic body (Article 50) cooled with a controlled furnace cooling rate of 1° C./minute to a temperature of 900° C. exhibiting a ΔE (skin-core) of 3.3 units; ΔC* (skin-core) of 1.4 units; and showing no gray-green discoloration.

FIG. 6M is an image of the skin, first core, and second core of a sintered ceramic body (Article 55) cooled with a controlled furnace cooling rate of 1° C./minute to a temperature of 900° C. exhibiting a ΔE (skin-core) of 1.4 units; ΔC* (skin-core) of 1.07 units; and showing no gray-green discoloration.

FIG. 6N is an image of the skin, first core, and second core of a sintered ceramic body (Article 56) cooled with a controlled furnace cooling rate of 1° C./minute to a temperature of 900° C. exhibiting a ΔE (skin-core) of 1.9 units; ΔC* (skin-core) of 0.64 units; and showing no gray-green discoloration.

FIG. 7A is an image of the skin, first core, and second core of a comparator sintered ceramic body (Comparator Article 1) cooled with a controlled furnace cooling rate of 11.7° C./minute to a temperature of 1200° C. exhibiting a ΔE (skin-core) of 16.9 units; ΔC* (skin-core) of 14.54 units; and showing gray-green discoloration.

FIG. 7B is an image of the skin, first core, and second core of a comparator sintered ceramic body (Comparator Article 41) cooled with a controlled furnace cooling rate of 11.7° C./minute to a temperature of 1200° C. exhibiting a ΔE (skin-core) of 5.5 units; ΔC* (skin-core) of 5.15 units; and showing gray-green discoloration.

FIG. 7C is an image of the skin, first core, and second core of a comparator sintered ceramic body (Comparator Article 42) cooled with a controlled furnace cooling rate of 11.7° C./minute to a temperature of 1200° C. exhibiting a ΔE (skin-core) of 10.3 units; ΔC* (skin-core) of 9.31 units; and showing gray-green discoloration.

FIG. 7D is an image of the skin, first core, and second core of a comparator sintered ceramic body (Comparator Article 43) cooled with a controlled furnace cooling rate of 11.7° C./minute to a temperature of 1200° C. exhibiting a ΔE (skin-core) of 3 units; ΔC* (skin-core) of 2.97 units; and showing no gray-green discoloration.

FIG. 7E is an image of the skin, first core, and second core of a comparator sintered ceramic body (Comparator Article 44) cooled with a controlled furnace cooling rate of 11.7° C./minute to a temperature of 1200° C. exhibiting a ΔE (skin-core) of 5.5 units; ΔC* (skin-core) of 5.26 units; and showing gray-green discoloration.

FIG. 7F is an image of the skin, first core, and second core of a comparator sintered ceramic body (Comparator Article 45) cooled with a controlled furnace cooling rate of 11.7° C./minute to a temperature of 1200° C. exhibiting a ΔE (skin-core) of 6.4 units; ΔC* (skin-core) of 6.11 units; and showing gray-green discoloration.

FIG. 8A is a line graph (temperature v. time) showing the temperature profile comprising a controlled furnace cooling rate of 1° C./minute from the peak sinter temperature of 1550° C. to 900° C. and the comparator temperature profile comprising a controlled furnace cooling rate of 11.7° C./minute from the peak sinter temperature of 1550° C. to 1200° C.

FIG. 8B is an image of the core of a sintered ceramic body (Article 27) cooled with a controlled furnace cooling rate of 1° C./minute to a temperature of 900° C. exhibiting a core C* chroma of 24.83 units; a ΔC* (skin-core) of 4.72 units; and showing no gray-green core discoloration.

FIG. 8C is an image of the core of a sintered ceramic body (Article 25) cooled with a controlled furnace cooling rate of 1° C./minute to a temperature of 900° C. exhibiting a core C* chroma of 24.88 units; a ΔC* (skin-core) of 3.91 units; and showing no gray-green core discoloration.

FIG. 8D is an image of the core of a sintered ceramic body (Article 35) cooled with a controlled furnace cooling rate of 1° C./minute to a temperature of 900° C. exhibiting a core C* chroma of 25.17 units; a ΔC* (skin-core) of 4.5 units; and showing no gray-green core discoloration.

FIG. 8E is an image of the core of a sintered ceramic body (Article 17) cooled with a controlled furnace cooling rate of 1° C./minute to a temperature of 900° C. exhibiting a core C* chroma of 25.94 units; a ΔC* (skin-core) of 5.64 units; and showing no gray-green core discoloration.

FIG. 8F is an image of the core of a sintered ceramic body (Article 29) cooled with a controlled furnace cooling rate of 1° C./minute to a temperature of 900° C. exhibiting a core C* chroma of 23.86 units; a ΔC* (skin-core) of 2.51 units; and showing no gray-green core discoloration.

FIG. 8G is an image of the core of a sintered ceramic body (Article 31) cooled with a controlled furnace cooling rate of 1° C./minute to a temperature of 900° C. exhibiting a core C* chroma of 24.03 units; a ΔC* (skin-core) of 4.17 units; and showing no gray-green core discoloration.

FIG. 8H is an image of the core of a sintered ceramic body (Article 19) cooled with a controlled furnace cooling rate of 1° C./minute to a temperature of 900° C. exhibiting a core C* chroma of 22.83 units; a ΔC* (skin-core) of 6.96 units; and showing no gray-green core discoloration.

FIG. 8I is an image of the core of a sintered ceramic body (Article 21) cooled with a controlled furnace cooling rate of 1° C./minute to a temperature of 900° C. exhibiting a core C* chroma of 22.83 units; a ΔC* (skin-core) of 10.84 units; and showing no gray-green core discoloration.

FIG. 8J is an image of the core of a sintered ceramic body (Article 33) cooled with a controlled furnace cooling rate of 1° C./minute to a temperature of 900° C. exhibiting a core C* chroma of 23.5 units; a ΔC* (skin-core) of 13.95 units; and showing no gray-green core discoloration.

FIG. 8K is an image of the core of a sintered ceramic body (Article 23) cooled with a controlled furnace cooling rate of 1° C./minute to a temperature of 900° C. exhibiting a core C* chroma of 21.82 units; a ΔC* (skin-core) of 16.23 units; and showing no gray-green core discoloration.

FIG. 9A is an image of the core of a comparator sintered ceramic body (Comparator Article 26) cooled with a controlled furnace cooling rate of 11.7° C./minute to a temperature of 1200° C. exhibiting a core C* chroma of 15.49 units; a ΔC* (skin-core) of 13.65 units; and showing gray-green core discoloration.

FIG. 9B is an image of the core of a comparator sintered ceramic body (Comparator Article 24) cooled with a controlled furnace cooling rate of 11.7° C./minute to a temperature of 1200° C. exhibiting a core C* chroma of 5.52 units; a ΔC* (skin-core) of 21.08 units; and showing gray-green core discoloration.

FIG. 9C is an image of the core of a comparator sintered ceramic body (Comparator Article 34) cooled with a controlled furnace cooling rate of 11.7° C./minute to a temperature of 1200° C. exhibiting a core C* chroma of 12.2 units; a ΔC* (skin-core) of 15.77 units; and showing gray-green core discoloration.

FIG. 9D is an image of the core of a comparator sintered ceramic body (Comparator Article 16) cooled with a controlled furnace cooling rate of 11.7° C./minute to a temperature of 1200° C. exhibiting a core C* chroma of 10.38 units; a ΔC* (skin-core) of 16.02 units; and showing gray-green core discoloration.

FIG. 9E is an image of the core of a comparator sintered ceramic body (Comparator Article 28) cooled with a controlled furnace cooling rate of 11.7° C./minute to a temperature of 1200° C. exhibiting a core C* chroma of 14.23 units; a ΔC* (skin-core) of 10.22 units; and showing gray-green core discoloration.

FIG. 9F is an image of the core of a comparator sintered ceramic body (Comparator Article 30) cooled with a controlled furnace cooling rate of 11.7° C./minute to a temperature of 1200° C. exhibiting a core C* chroma of 14.57 units; a ΔC* (skin-core) of 11.87 units; and showing gray-green core discoloration.

FIG. 9G is an image of the core of a comparator sintered ceramic body (Comparator Article 18) cooled with a controlled furnace cooling rate of 11.7° C./minute to a temperature of 1200° C. exhibiting a core C* chroma of 13.48 units; a ΔC* (skin-core) of 10.41 units; and showing gray-green core discoloration.

FIG. 9H is in an image of the core of a comparator sintered ceramic body (Comparator Article 20) cooled with a controlled furnace cooling rate of 11.7° C./minute to a temperature of 1200° C. exhibiting a core C* chroma of 17.56 units; a ΔC* (skin-core) of 13.04 units; and showing gray-green core discoloration.

FIG. 9I is an image of the core of a comparator sintered ceramic body (Comparator Article 32) cooled with a controlled furnace cooling rate of 11.7° C./minute to a temperature of 1200° C. exhibiting a core C* chroma of 11.83 units; a ΔC* (skin-core) of 24.92 units; and showing gray-green core discoloration.

FIG. 9J is an image of the core of a comparator sintered ceramic body (Comparator Article 22) cooled with a controlled furnace cooling rate of 11.7° C./minute to a temperature of 1200° C. exhibiting a core C* chroma of 12.17 units; a ΔC* (skin-core) of 20.64 units; and showing gray-green core discoloration.

FIG. 10 is a line graph (temperature v. time) showing a temperature profile of an aspect of the method disclosed herein comparing the temperature of the furnace versus the temperature of a thermocouple embedded in ceramic material; demonstrating that the furnace temperature and thermocouple temperature closely track with the temperature profile.

FIGS. 11A-11B are images of the skin (FIG. 11A) and core (FIG. 11B) of a comparator sintered ceramic body (Comparator Article 59) comprising 3 mol % yttria and 0.72 wt. % Fe₂O₃ cooled with a controlled furnace cooling rate of 11.7° C./minute to a temperature of 1200° C. exhibiting a core CIELAB a* of −1.41; Δb (skin-core) of 14.67; Δh (core-skin) of 19.64°; and a ΔC (skin-core) of 15.59; and showing gray-green discoloration.

FIGS. 11C-11D are images of the skin (FIG. 11C) and core (FIG. 11D) of a comparator sintered ceramic body (Comparator Article 61) comprising 8 mol % yttria and 0.72 wt. % Fe₂O₃ cooled with a controlled furnace cooling rate of 11.7° C./minute to a temperature of 1200° C. exhibiting a core CIELAB a* of −1.4; Δb (skin-core) of 6.50; Δh (core-skin) of 0.96°; and a ΔC (skin-core) of 6.48; and showing gray-green discoloration.

FIGS. 11E-11F are images of the skin (FIG. 11E) and core (FIG. 11F) of a comparator sintered ceramic body (Comparator Article 63) comprising 5 mol % yttria and 0.72 wt. % Fe₂O₃ cooled with a controlled furnace cooling rate of 11.7° C./minute to a temperature of 1200° C. exhibiting a core CIELAB a* of −2.27; Δb (skin-core) of 10.49; Δh (core-skin) of 10.58°; and a ΔC (skin-core) of 10.4; and showing gray-green discoloration.

FIGS. 11G-11H are images of the skin (FIG. 11G) and core (FIG. 11H) of a sintered ceramic body (Article 60) comprising 3 mol % yttria and 0.72 wt. % Fe₂O₃ cooled with a controlled furnace cooling rate of 1° C./minute to a temperature of 900° C. exhibiting a core CIELAB a* of 9.49; Δb (skin-core) of 1.26; Δh (core-skin) of 1.73°; and a ΔC (skin-core) of 1.65; and showing no gray-green discoloration.

FIGS. 11I-11J are images of the skin (FIG. 11I) and core (FIG. 11J) of a sintered ceramic body (Article 62) comprising 5 mol % yttria and 0.72 wt. % Fe₂O₃ cooled with a controlled furnace cooling rate of 1° C./minute to a temperature of 900° C. exhibiting a core CIELAB a* of 0.28; Δb (skin-core) of 6.98; Δh (core-skin) of 4.11°; and a ΔC (skin-core) of 7.1; and showing low gray-green discoloration.

FIGS. 11K-11L are images of the skin (FIG. 11K) and core (FIG. 11L) of a sintered ceramic body (Article 64) comprising 5 mol % yttria and 0.72 wt. % Fe₂O₃ cooled with a controlled furnace cooling rate of 1° C./minute to a temperature of 900° C. exhibiting a core CIELAB a* of 5.57; Δb (skin-core) of 2.51; Δh (core-skin) of 3.18°; and a ΔC (skin-core) of 2.95; and showing low gray-green discoloration.

FIGS. 12A-12B are images of the skin (FIG. 12A) and core (FIG. 12B) of a comparator sintered body (Comparator Article 75) comprising 4 mol % yttria and 0.2 wt. % Fe₂O₃ cooled with a controlled furnace cooling rate of 11.7° C./minute to a temperature of 1200° C. exhibiting a core CIELAB a* of −2.25; Δb (skin-core) of 15.71; Δh (core-skin) of 12.02°; and a ΔC (skin-core) of 15.53; and showing gray-green discoloration.

FIGS. 12C-12D are images of the skin (FIG. 12C) and core (FIG. 12D) of a sintered ceramic body (Article 76) comprising 4 mol % yttria and 0.2 wt. % Fe₂O₃ cooled with a controlled furnace cooling rate of 1° C./minute to a temperature of 900° C. exhibiting a core CIELAB a* of 3.55; Δb (skin-core) of 3.32; Δh (core-skin) of 2.02°; and a ΔC (skin-core) of 3.5; and showing no gray-green discoloration.

FIGS. 13A-13D are bar graphs comparing the CIELAB a* of the core (FIG. 13A), CIELAB b* difference Δb (skin-core) (FIG. 13B), CIELAB hue angle difference (Δh_{ab}) of core-skin (FIG. 13C), CIELAB chroma difference (ΔC*_{ab}) of skin-core (FIG. 13D) of sintered ceramic bodies with a controlled furnace cooling rate of 1° C./minute to a temperature of 900° C. of Article 46 (0.06 wt. % Fe₂O₃, 4 mol % yttria), Article 51 (0.06 wt. % Fe₂O₃, 4 mol % yttria), Article 47 (0.08 wt. % Fe₂O₃, 3.9 mol % yttria), Article 53 (0.08 wt. % Fe₂O₃, 3.9 mol % yttria), Article 56 (0.08 wt. % Fe₂O₃, 3.9 mol % yttria), Article 52 (0.1 wt. % Fe₂O₃, 4 mol % yttria), Article 48 (0.11 wt. % Fe₂O₃, 3.9 mol % yttria), Article 54 (0.11 wt. % Fe₂O₃, 3.9 mol % yttria), Article 49 (0.13 wt. % Fe₂O₃, 3.8 mol % yttria), Article 55 (0.14 wt. % Fe₂O₃, 3.9 mol % yttria), Article 50 (0.16 wt. % Fe₂O₃, 3.7 mol % yttria), Article 39 (0.2 wt. % Fe₂O₃, 4 mol % yttria), Article 76 (0.2 wt. % Fe₂O₃, 4 mol % yttria), Article 60 (0.72 wt. % Fe₂O₃, 3 mol % yttria), Article 64 (0.72 wt. % Fe₂O₃, 5 mol % yttria), Article 62 (0.72 wt. % Fe₂O₃, 8 mol % yttria), versus comparator articles comprising a controlled furnace cooling rate of 11.7° C. to a temperature of 1200° C. of Comparator Article 43 (0.1 wt. % Fe₂O₃, 4 mol % yttria), Comparator Article 41 (0.11 wt. % Fe₂O₃, 3.9 mol % yttria), Comparator Article 44 (0.11 wt. % Fe₂O₃, 3.9 mol % yttria), Comparator Article 45 (0.12 wt. % Fe₂O₃, 3.8 mol % yttria, Comparator Article 42 (0.13 wt. % Fe₂O₃, 3.8 mol % yttria), Comparator Article 1 (0.2 wt. % Fe₂O₃, 4 mol % yttria), Comparator Article 75 (0.2 wt. % Fe₂O₃, 4 mol % yttria), Comparator Article 59 (0.72 wt. % Fe₂O₃, 3 mol % yttria), Comparator Article 63 (0.72 wt. % Fe₂O₃, 5 mol % yttria), Comparator Article 61 (0.72 wt. % Fe₂O₃, 8 mol % yttria).

FIGS. 14A-14E are bar graphs showing the CIELAB b* of the core (FIG. 14A), CIELAB chroma (C*_{ab}) of the core (FIG. 14B), CIELAB chroma difference (ΔC*_{ab}) of skin-core (FIG. 14C), saturation (C*/L*) of the core (FIG. 14D), CIELAB hue angle difference (Δh_{ab}) of core-skin (FIG. 14E) of sintered ceramic bodies with a controlled furnace cooling rate of 1° C./minute to a temperature of 900° C. of Article 27 (0.2 wt. % Fe₂O₃, 3 mol % yttria), Article 17 (0.2 wt. % Fe₂O₃, 4 mol % yttria), Article 25 (0.2 wt. % Fe₂O₃, 4 mol % yttria), Article 35 (0.2 wt. % Fe₂O₃, 4 mol % yttria), Article 29 (0.2 wt. % Fe₂O₃, 5.3 mol % yttria), Article 19 (0.25 wt. % Fe₂O₃, 5.3 mol % yttria), Article 31 (0.25 wt. % Fe₂O₃, 5.3 mol % yttria), Article 21 (0.5 wt. % Fe₂O₃, 3 mol % yttria), Article 33 (0.5 wt. % Fe₂O₃, 4 mol % yttria), Article 23 (0.5 wt. % Fe₂O₃, 5.3 mol % yttria) versus comparator articles comprising a controlled furnace cooling rate of 11.7° C. to a temperature of 1200° C. of Comparator Article 26 (0.2 wt. % Fe₂O₃, 3 mol % yttria), Comparator Article 16 (0.2 wt. % Fe₂O₃, 4 mol % yttria), Comparator Article 24 (0.2 wt. % Fe₂O₃, 4 mol % yttria), Comparator Article 34 (0.2 wt. % Fe₂O₃, 4 mol % yttria), Comparator Article 28 (0.2 wt. % Fe₂O₃, 5.3 mol % yttria), Comparator Article 18 (0.25 wt. % Fe₂O₃, 5.3 mol % yttria), Comparator Article 30 (0.25 wt. % Fe₂O₃, 5.3 mol % yttria, Comparator Article 20 (0.5 wt. % Fe₂O₃, 3 mol % yttria), Comparator Article 32 (0.5 wt. % Fe₂O₃, 4 mol % yttria), Comparator Article 22 (0.5 wt. % Fe₂O₃, 5.3 mol % yttria).

FIG. 15 is a line graph (temperature vs. time) showing the temperature profile comprising a controlled furnace cooling rate of 1° C./minute from the peak sinter temperature of 1550° C. to 900° C. and the comparator temperature profile comprising a controlled furnace cooling rate of 11.7° C./minute from the peak sinter temperature of 1550° C. to 1200° C.

FIGS. 16A-16D are images of the skin and core (FIG. 16A) of a comparator sintered rectangular block (Comparator Article 77) comprising yttria (2.7 mol %), Fe₂O₃ (0.06 wt. %), Mn (3 ppm), and Er (0.25 wt. %) produced with a controlled furnace cooling rate of 11.7° C./minute to a temperature of 1200° C.; skin and core (FIG. 16B) of a sintered rectangular block (Article 78) comprising yttria (2.7 mol %), Fe₂O₃ (0.06 wt. %), Mn (3 ppm), and Er (0.25 wt. %) produced with a controlled furnace cooling rate of 1° C./minute to a temperature of 900° C.; the skin and core (FIG. 16C) of a comparator sintered rectangular block (Comparator Article 79) comprising yttria (2.8 mol %), Fe₂O₃ (0.11 wt. %), Mn (13 ppm), and Er (0.12 wt. %) produced with a controlled furnace cooling rate of 11.7° C./minute to a temperature of 1200° C.; and skin and core (FIG. 16D) of a sintered rectangular block (Article 80) comprising yttria (2.8 mol %), Fe₂O₃ (0.11 wt. %), Mn (13 ppm), and Er (0.12 wt. %) produced with a controlled furnace cooling rate of 1° C./minute to a temperature of 900° C.

### DETAILED DESCRIPTION

### I. Overview of Terms

Both the foregoing general description and the following detailed description are exemplary and explanatory only and are not intended to limit the scope of the present disclosure.

As used herein, the use of the singular includes the plural unless specifically stated otherwise. For example, the singular forms “a”, “an” and “the” as used in the specification also include plural aspects unless the context dictates otherwise. Similarly, any singular term used in the specification also means plural or vice versa, unless the context dictates otherwise.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The term “or combinations thereof” as used herein refers to all permutations and combinations of the listed items preceding the term. For example, “A, B, C, or combinations thereof” is intended to include at least: A, B, C, AB, AC, BC, or ABC, and if order is important in a particular context, also BA, CA, CB, ACB, CBA, BCA, BAC, or CAB. Continuing with this example, expressly included are combinations that contain repeats of one or more item or term, such as BB, AAA, AAB, BBC, AAABCCCC, CBBAAA, CABABB, and so forth.

All literature and similar materials cited in this application including, but not limited to, patents, patent applications, articles, books, treatises, and internet web pages, regardless of the format of such literature and similar materials, are expressly incorporated by reference in their entirety for any purpose. In the event that one or more of the incorporated literature and similar materials defines or uses a term in such a way that it contradicts that term's definition in this application, the definitions provided by this specification control. While the present teachings are described in conjunction with various embodiments, it is not intended that the present teachings be limited to such embodiments. On the contrary, the present teachings encompass various alternatives, modifications, and equivalents, as will be appreciated by a person of ordinary skill in the art in light of the present teachings.

To facilitate review of the various aspects of the disclosure, the following explanations of specific terms are provided.

Chroma (C*_{ab}): The colorfulness of an area judged as a proportion of the brightness of a similarly illuminated area that appears grey, white, or highly transmitting.

CIELAB Color Space (CIE L*a*b* Color Space): A three-dimensional, approximately uniform color space produced by plotting the rectangular coordinates L*, a*, and b*, where L* represents the lightness of stimulus, a* as redness/greenness, and b* as yellowness/blueness.

Controlled Furnace Cooling Rate: A cooling rate that is regulated such that the temperature of the medium decreases at a predetermined rate via a furnace.

Hue: An attribute of a visual perception according to which an area appears to be similar to one of the colors such as red, yellow, green, and blue, or any combination thereof, considered in a closed ring

Saturation: The colorfulness of an area judged in proportion to its brightness and/or a description of the chroma of an area judged in proportion to its lightness.

### II. Introduction

Iron is a common dopant used in yttria-stabilized zirconia ceramic material for producing yellow hues in sintered ceramic bodies. However, sintered masses doped with iron still exhibit yellow hues at their surface and subsurface and further exhibit undesirable gray-green discoloration. Accordingly, there is a need in the art for new materials and methods that can utilize iron-containing pre-colored YSZ powders and mitigate color discoloration and undesirable gray-green hues.

Disclosed herein is a material, comprising a sintered ceramic comprising iron (III) oxide (Fe₂O₃) and yttria-stabilized zirconia with no color discoloration or a commercially desirable discoloration and no undesirable gray-green hues or a commercially desirable amount of gray-green hues.

Also disclosed herein is a method of forming a sintered ceramic body by introducing the iron (III) oxide (Fe₂O₃) via: (i) a pre-integrated yttria-stabilized zirconia powder to form a mixture; (ii) spraying a solution comprising iron (III) nitrate nonahydrate salt in a solvent onto a non-shaded pressable yttria-stabilized zirconia powder to form a mixture; or (iii) mixing the resulting mixture of (ii) with non-shaded yttria-stabilized powder; pressing or casting the resulting mixture into a green block; bisque the green block resulting in a bisqued body; and sintering the bisqued body resulting in the sintered ceramic body. In other aspects, the method of forming sintered ceramic bodies comprises introducing the iron (III) oxide (Fe₂O₃) via: (i) a pre-integrated yttria-stabilized zirconia powder to form a mixture or (ii) mixing an iron (III) oxide (Fe₂O₃) powder with yttria-stabilized zirconia powder to form a mixture; dispersing the mixture in a slurry comprising water and a dispersing agent; slip-casting the resulting mixture in a bisqued-body; and sintering the bisqued body resulting in the sintered ceramic body.

A method for making a sintered ceramic body is also disclosed herein, the method comprising introducing an iron-containing, yttria-stabilized zirconia ceramic material into a furnace; heating the ceramic material in the furnace to a furnace temperature ranging from 1200° C. to 1700° C. for at least 5 minutes; and cooling the ceramic material at a controlled furnace cooling rate ranging from greater than 0° C./minute to 3° C./minute to a temperature ranging from 800° C. to 1200° C. In certain aspects, the iron-containing, yttria-stabilized zirconia ceramic material is a pre-sintered ceramic material.

### III. Material

Certain disclosed aspects of the present disclosure concerns a material comprising zirconia and an iron-containing component. In particular aspects, the sintered ceramic may comprise zirconia, partially stabilized or stabilized zirconia, such as tetragonal or cubic zirconia, and mixtures thereof. The sintered ceramic may comprise a yttria-stabilized zirconia that has been stabilized with yttria content ranging from greater than 0 mol % to 8.0 mol %, such as from 0.5 mol % to 8.0 mol %, 1.0 mol % to 8.0 mol %, 1.5 mol % to 8.0 mol %, 2.0 mol % to 8.0 mol %, 2.5 mol % to 8.0 mol %, 3.0 mol % to 8.0 mol %, 3.5 mol % to 8.0 mol %, 4.0 mol % to 8.0 mol %, 4.5 mol % to 8.0 mol %, 5.0 mol % to 8.0 mol %, 5.5 mol % to 8.0 mol %, 6.0 mol % to 8.0 mol %, 6.5 mol % to 8.0 mol %, 7.0 mol % to 8.0 mol %, or 7.5 mol % to 8.0 mol %. In aspects disclosed herein, the ceramic material may comprise aluminum oxide, or other known oxides for use in ceramic materials, or mixtures thereof. In certain aspects, the yttria-stabilized zirconia powders may comprise alumina at a concentration of from 0 wt. % to 0.25 wt. %, relative to the zirconia powder.

In certain aspects, the sintered ceramic comprises an iron-containing component such as, but not limited to, iron (III) oxide (Fe₂O₃). Typically, the iron-containing component such as, but not limited to, Fe₂O₃ is added to impart a yellow-orange color. In some aspects disclosed herein, the sintered ceramic may comprise amounts of Fe₂O₃ ranging from greater than 0 wt. % to 0.80 wt. %, based on the total weight of the sintered ceramic, such as from greater than 0 wt. % to 0.75 wt. %, greater than 0 wt. % to 0.70 wt. %, greater than 0 wt. % to 0.65 wt. %, greater than 0 wt. % to 0.60 wt. %, greater than 0 wt. % to 0.55 wt. %, greater than 0 wt. % to 0.50 wt. %, greater than 0 wt. % to 0.45 wt. %, greater than 0 wt. % to 0.40 wt. %, greater than 0 wt. % to 0.35 wt. %, greater than 0 wt. % to 0.30 wt. %, greater than 0 wt. % to 0.25 wt. %, greater than 0 wt. % to 0.20 wt. %, greater than 0 wt. % to 0.15 wt. %, greater than 0 wt. % to 0.10 wt. %, or greater than 0 wt. % to 0.05 wt. % (based on the total weight of the sintered ceramic).

In some aspects disclosed herein, the sintered ceramic may further comprise other metal-containing components, including metallic compounds and metallic complexes having one or more metallic elements of transition metals from groups 3-14 on the periodic table of elements, rare earth metals, or mixtures of transition metals rare earth metals. In particular aspects, the metal-containing component can be coloring agent. In certain aspects, the coloring agent may comprise one or more metal-containing components having a metal or metal ion including, but not limited to, erbium, chromium, cobalt, manganese, praseodymium, vanadium, titanium, nickel, copper, zinc, and/or terbium, to provide a coloring effect. In particular disclosed herein can include coloring agents and esthetic additives used to obtain shades in final sintered restorations that meet desired dental shaded, such as the 16 VITA® classical shades, and/or to obtain desired opalescence or fluorescence properties for dental applications. Still other optional additives include alternative stabilizer materials, such as cerium oxide and/or magnesium oxide. Still other optional additives include grain growth inhibitors, sintering aids, and/or toughening aids.

In certain aspects, the sintered ceramic further comprises an erbium content ranging from greater than 0 wt. % to 0.55 wt. %, based on the total weight of the sintered ceramic, such as from greater than 0 wt. % to 0.50 wt. %, greater than 0 wt. % to 0.45 wt. %, greater than 0 wt. % to 0.40 wt. %, greater than 0 wt. % to 0.35 wt. %, greater than 0 wt. % to 0.30 wt. %, greater than 0 wt. % to 0.25 wt. %, greater than 0 wt. % to 0.20 wt. %, greater than 0 wt. % to 0.15 wt. %, greater than 0 wt. % to 0.10 wt. %, or greater than 0 wt. % to 0.05 wt. %.

In aspects disclosed herein, the sintered ceramic further comprises a cobalt content ranging from greater than 0 wt. % to 0.005 wt. %, based on the total weight of the sintered ceramic, such as from greater than 0 wt. % to 0.004 wt. %, greater than 0 wt. % to 0.003 wt. %, greater than 0 wt. % to 0.002 wt. %, or greater than 0 wt. % to 0.001 wt. %.

In certain, the sintered ceramic further comprises a manganese content ranging from greater than 0 wt. % to 0.0013 wt. % (13 ppm), based on the total weight of the sintered ceramic such as from greater than 0 wt. % to 0.0012 wt. % (12 ppm), greater than 0 wt. % to 0.0011 wt. % (11 ppm), greater than 0 wt. % to 0.0010 wt. % (10 ppm), greater than 0 wt. % to 0.0009 wt. % (9 ppm), greater than 0 wt. % to 0.0008 wt. % (8 ppm), greater than 0 wt. % to 0.0007 wt. % (7 ppm), greater than 0 wt. % to 0.0006 wt. % (6 ppm), greater than 0 wt. % to 0.0005 wt. % (5 ppm), greater than 0 wt. % to 0.0004 wt. % (4 ppm), greater than 0 wt. % to 0.0003 wt. % (3 ppm), greater than 0 wt. % to 0.0002 wt. % (2 ppm), or greater than 0 wt. % to 0.0001 wt. % (1 ppm).

In some aspects, the sintered ceramic can be a sintered ceramic body molded into a shape such as, but not limited to, a rectangular block, cylindrical disk, near net shape, or a form that approximates the size and/or shape of a single or multi-unit dental restoration such as, but not limited to, crown, on-lay, bridge including a multi-unit bridge comprising restorations having one or more tooth structures, a partial or full solid-body denture, or a supporting structure (e.g., implant, abutment).

In aspects disclosed herein, the sintered ceramic body can exhibit desirable consistency and/or uniformity in color expression throughout the sintered volume. For example, the sintered ceramic body can exhibit no or low/reduced gray-green color discoloration and/or non-uniformity of color expression.

In some aspects, the sintered ceramic body can be sectioned to expose a subsurface and/or core for determining color expression consistency and/or uniformity. In aspects disclosed herein, CIELAB measurements can be performed from scanning one or more portion of one or more sectioned surfaces using an imaging device and computer software. The imaging device can be an imaging spectrophotometer such as, but not limited to, a SpectroShade Micro II. In certain aspects, SpectroShade Analysis software can be used to collect CIELAB values from an area at the approximate center of the mid scan of each sample face. In particular aspects, a horizontal line scan of CIELAB values adjacent areas from left to right across each mid scan of each face can be collected by SpectroShade Analysis software and desktop automation tools to automate selection and data collection process. In other aspects, scan images of the skin and core faces can be extracted and arranged for qualitative comparison.

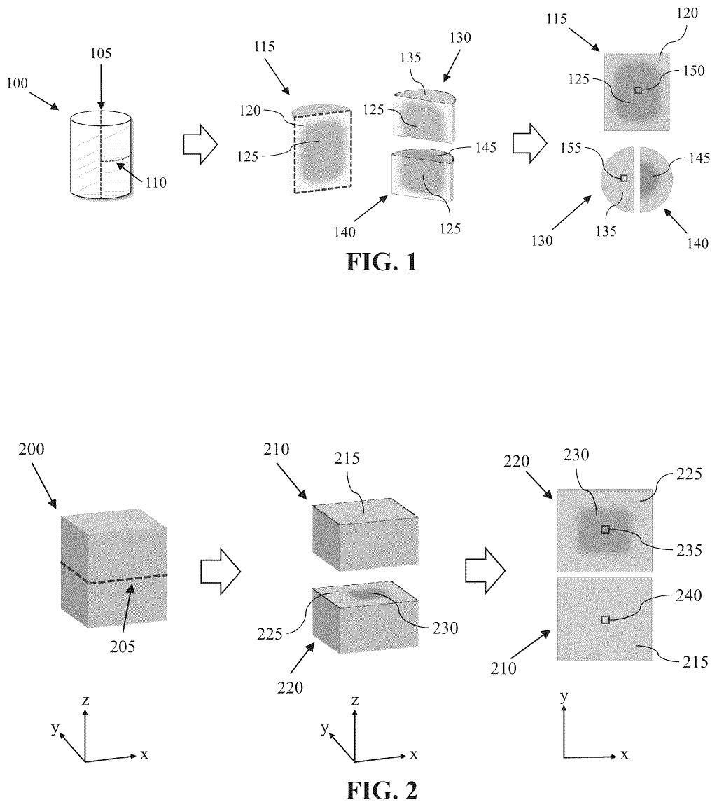

In certain aspects, a sintered cylindrical ceramic body can be sectioned in half length-wise and/or sectioned at a region of max discoloration such as, but not limited to, a cross-sectional center comprising a core perpendicular to the half comprising the length-wise component. In a non-limiting example, FIG. 1 is a schematic illustrating a cylindrical ceramic body 100 sectioned in half length-wise 105 and sectioned at the cross-sectional center 110 to produce rectangular-shaped half 115 comprising a face 120 and full view of core 125, a first sectioned component 130, and second sectioned component 140. The sections can be mounted, wherein the face 120 of rectangular-shaped half 115 comprising a first core component 125, face 135 of sectioned piece 130 comprising the skin, and second core component 145 of sectioned piece 140 are exposed and polished and scanned using an imaging spectrophotometer to produce and collect one or more CIELAB values from the center portion of the full core face 150 to a portion of the skin face 155.

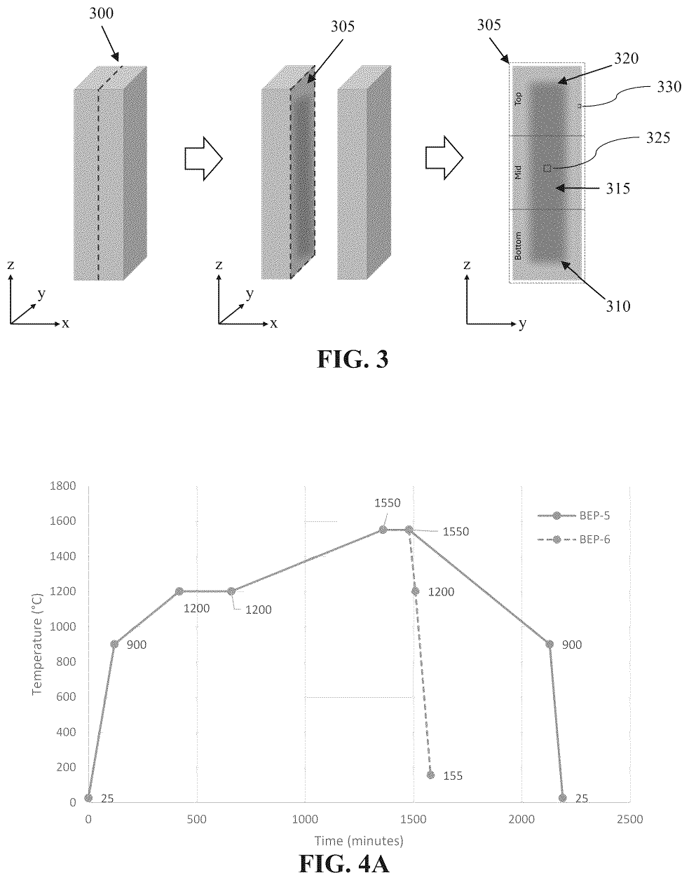

In some aspects, a sintered rectangular ceramic body can be sectioned in half to expose the core. In a non-limiting example, FIG. 2 is a schematic illustrating a rectangular ceramic body 200 sectioned in half 205 to expose the core 230. Both halves can be mounted and polished, the first half 210 having the top/outer face 215 exposed and the second half 220 having a mid-portion face 225 and core 230 exposed. The two halves can be scanned using an imaging spectrophotometer to produce and collect one or more CIELAB values from the center 235 of the full core face 225 to a portion 240 of the skin face 215. In another non-limiting example, FIG. 3 is a schematic illustrating a rectangular ceramic body 300 sectioned in half exposing a core face 305, wherein a first scan is taken at a bottom portion of the core face 310 (face in contact with crucible during sintering), a second scan is taken at a middle portion of the core face 315, and a third scan is taken at a top portion of the core face 320 to produce and collect one or more CIELAB values at the core center 325 and near-edge perimeter of skin 330.

In some aspects, a material comprising iron (III) oxide (Fe₂O₃) and yttria-stabilized zirconia; a distance from a cross-sectional center comprising a core to a perimeter portion of the sintered ceramic ranging from greater than 0 millimeters to 15 millimeters; and a CIELAB a* at the core greater than −2. In some aspects, the distance from the cross-sectional center comprising the core to the perimeter portion of the sintered ceramic has a range from greater than 0 millimeters to 15 millimeters, such as from 1 millimeters to 15 millimeters, 2 millimeters to 15 millimeters, 3 millimeters to 15 millimeters, 4 millimeters to 15 millimeters, 5 millimeters to 15 millimeters, 6 millimeters to 15 millimeters, 7 millimeters to 15 millimeters, 8 millimeters to 15 millimeters, 9 millimeters to 15 millimeters, 10 millimeters to 15 millimeters, 11 millimeters to 15 millimeters, 12 millimeters to 15 millimeters, 13 millimeters to 15 millimeters, or 14 millimeters to 15 millimeters.

In particular aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a first CIELAB b* at the core greater than 20. In certain aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a first CIELAB b* at the core less than or equal to 8 points below a second CIELAB b* at the perimeter portion of the sintered ceramic. In particular aspects disclosed herein, the sintered ceramic may comprise a first CIELAB b* at the core ranging from −1 to 8 points below a second CIELAB b* at the perimeter portion of the sintered ceramic, such as from a first CIELAB b* at the core ranging from 1 point to 8 points below a second CIELAB b* at the perimeter portion of the sintered ceramic, a first CIELAB b* at the core ranging from 2 points to 8 points below a second CIELAB b* at the perimeter portion of the sintered ceramic, a first CIELAB b* at the core ranging from 3 points to 8 points below a second CIELAB b* at the perimeter portion of the sintered ceramic, a first CIELAB b* at the core ranging from 4 points to 8 points below a second CIELAB b* at the perimeter portion of the sintered ceramic, a first CIELAB b* at the core ranging from 5 points to 8 points below a second CIELAB b* at the perimeter portion of the sintered ceramic. a first CIELAB b* at the core ranging from 6 points to 8 points below a second CIELAB b* at the perimeter portion of the sintered ceramic, a first CIELAB b* at the core ranging from 7 points to 8 points below a second CIELAB b* at the perimeter portion of the sintered ceramic. In certain aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a CIELAB b* difference (Δb*) of the skin minus the core less than 8. In particular aspects disclosed herein, the material can have a CIELAB b* difference (Δb*) of the skin minus the core ranging from −1 to 8, such as from 0 to 8, 1 to 8, 2, to 8, 3 to 8, 4 to 8, 5 to 8, 6 to 8, or 7 to 8.

In certain aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a first CIELAB hue angle (h_{ab}) at the core ranging from less than or equal to 5 degrees greater than a second CIELAB hue angle (h_{ab}) at the perimeter portion. In particular aspects disclosed herein, the material can have a first CIELAB hue angle (h_{ab}) at the core ranging from −2 to 5 degrees greater than a second CIELAB hue angle (h_{ab}) at the perimeter portion, such as from a first CIELAB hue angle (h_{ab}) at the core ranging from 1 degree to 5 degrees greater than a second CIELAB hue angle (h_{ab}) at the perimeter portion, a first CIELAB hue angle (h_{ab}) at the core ranging from 2 degrees to 5 degrees greater than a second CIELAB hue angle (h_{ab}) at the perimeter portion, a first CIELAB hue angle (h_{ab}) at the core ranging from 3 degrees to 5 degrees greater than a second CIELAB hue angle (h_{ab}) at the perimeter portion, or a first CIELAB hue angle (h_{ab}) at the core ranging from 4 degrees to 5 degrees greater than a second CIELAB hue angle (h_{ab}) at the perimeter portion.

In particular aspects disclosed herein, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a CIELAB hue angle difference (Δh_{ab}) between the core and perimeter less than or equal to 5 degrees. In particular aspects disclosed herein, the material can have a CIELAB hue angle difference (Δh_{ab}) between the core and perimeter from −2 to 5 degrees, such as from −1 to 5 degrees, 0 to 5 degrees, 1 to 5 degrees, 2 to 5 degrees, 3 to 5 degrees, or 4 to 5 degrees.

In certain aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a chroma (C*_{ab}) value of 20 or greater at the core. In certain aspects, the material comprising iron (III) oxide (Fe₂O₃) and yttria-stabilized zirconia; the distance from a cross-sectional center comprising the core to the perimeter portion of the sintered ceramic ranging from 0 millimeters to 15 millimeters; and a CIELAB chroma (C*_{ab}) at the core ranging from 0 points to 4 points below that of a perimeter of the sintered body, such as from 1 point to 4 points below that of a perimeter of the sintered body, 2 points to 4 points below that of a perimeter of the sintered body, or 3 points to 4 points below that of a perimeter of the sintered body.

In particular aspects disclosed herein, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a CIELAB chroma difference (ΔC*_{ab}) between a perimeter and the core ranging from 0 to 16, such as from 1 to 16, 2 to 16, 3 to 16, 4 to 16, 5 to 16, 6 to 16, 7 to 16, 8 to 16, 9 to 16, 10 to 16, 11 to 16, 12 to 16, 13 to 16, 14 to 16, or 15 to 16.

In some aspects, the material comprising iron (III) oxide (Fe₂O₃) and yttria-stabilized zirconia; the distance from a cross-sectional center comprising the core to the perimeter portion of the sintered ceramic ranging from greater than 0 millimeters to 15 millimeters; and a CIELAB saturation (ratio of chroma over lightness; C*ab/L*) of ranging from greater than 0 to 0.35 at the core of the sintered body, such as from 0.05 to 0.35 at the core of the sintered body, 0.10 to 0.35 at the core of the sintered body, 0.15 to 0.35 at the core of the sintered body, 0.20 to 0.35 at the core of the sintered body, 0.25 to 0.35 at the core of the sintered body, or 0.30 to 0.35 at the core of the sintered body.

In some aspects the material comprising: a sintered ceramic comprising iron (III) oxide (Fe₂O₃) and yttria-stabilized zirconia; a distance from a cross-sectional center comprising a core to a perimeter portion of the sintered ceramic ranging from greater than 0 millimeters to 15 millimeters; and (i) a CIELAB a* at the core greater than −2, (ii) a first CIELAB b* at the core ranging from −2 points to 8 points below a second CIELAB b* at the perimeter portion of the sintered ceramic, (iii) a first CIELAB hue angle (h_{ab}) at the core of less than or equal to 5 degrees below a second CIELAB hue angle (h_{ab}) at the perimeter portion; (iv) or any combination of (i), (ii), and/or (iii); can further comprise a flexural strength of greater than or equal to 800 MPa.

### IV. Method of Making

Aspects of the present disclosure also concern a method for making the material disclosed herein, the method for making comprising: introducing an iron-containing, yttria-stabilized zirconia ceramic material into a furnace; heating the ceramic material in the furnace to a furnace temperature ranging from 1200° C. to 1700° C. for at least 5 minutes; and cooling the ceramic material at a controlled furnace cooling rate ranging from greater than 0° C./minute to 3° C./minute to a temperature ranging from 800° C. to 1200° C.

In some aspects, the method comprises heating the ceramic material in the furnace to a furnace temperature ranging from 1200° C. to 1700° C. for at least 5 minutes, such as from heating the ceramic material in the furnace to a furnace temperature ranging from 1300° C. to 1700° C. for at least 5 minutes, heating the ceramic material in the furnace to a furnace temperature ranging from 1400° C. to 1700° C. for at least 5 minutes, heating the ceramic material in the furnace to a furnace temperature ranging from 1500° C. to 1700° C. for at least 5 minutes, or heating the ceramic material in the furnace to a furnace temperature ranging from 1600° C. to 1700° C. for at least 5 minutes. In certain aspects, the method comprises cooling the ceramic material at a controlled furnace cooling rate ranging from greater than 0° C./minute to 3° C./minute to a temperature ranging from 800° C. to 1200° C. In some aspects, a controlled furnace cooling rate can range from 1° C./minute to 3° C./minute or 2° C./minute to 3° C./minute. In certain aspects, the cooling the ceramic material at a controlled furnace cooling rate ranging from greater than 0° C./minute to 3° C./minute to a temperature ranging from 800° C. to 1200° C., such as from 900° C. to 1200° C., 1000° C. to 1200° C., or 1100° C. to 1200° C.

In some aspects, the sintered ceramic body disclosed herein is formed by introducing the iron (III) oxide (Fe₂O₃) via: (i) a pre-integrated yttria-stabilized zirconia powder to form a mixture, (ii) spraying a solution comprising iron (III) nitrate nonahydrate salt or other soluble iron-containing salt in a solvent onto a non-shaded pressable yttria-stabilized zirconia powder to form a mixture, or (iii) mixing the resulting mixture of (ii) with non-shaded yttria-stabilized powder; pressing or casting the resulting mixture into a green block; bisque the green block resulting in a bisqued body; and sintering the bisqued body resulting in the sintered ceramic body.

In particular aspects disclosed herein, the starting materials may comprise unstabilized zirconia (e.g., containing no yttria). In some aspects, the unstabilized zirconia can be used to obtain a desired yttria concentration for a given zirconia powder starting material. Where actual yttria mol % in yttria-stabilized zirconia material may vary from nominal values, actual mol % yttria may be calculated, for example, based on compositional information received from manufacturer certification. In aspects disclosed herein, the sintered ceramic can be produced from commercially available pre-colored yttria-stabilized zirconia powders comprising iron, such as, but not limited to, Tosoh, Daiichi, Sinocera, and Treibacher.

In some aspects, a solution comprising iron (III) nitrate nonahydrate salt in a solvent is sprayed into a mixer comprising yttria-stabilized zirconia powder to form a mixture. In certain aspects, the solution comprises from greater than 0% to 50% iron (III) nitrate nonahydrate or other soluble iron-containing salt such as from 10% to 50% % iron (III) nitrate nonahydrate or other soluble iron-containing salt, 20% to 50% % iron (III) nitrate nonahydrate or other soluble iron-containing salt, 30% to 50% iron (III) nitrate nonahydrate or other soluble iron-containing salt, 35% to 50% iron (III) nitrate nonahydrate or other soluble iron-containing salt, 40% to 50% iron (III) nitrate nonahydrate or other soluble iron-containing salt, or 45% to 50% iron (III) nitrate nonahydrate or other soluble iron-containing salt.

In some aspects, the sintered ceramic body is formed by: introducing the iron (III) oxide (Fe₂O₃) via: (i) a pre-integrated yttria-stabilized zirconia powder to form a mixture or (ii) mixing an iron (III) oxide (Fe₂O₃) powder with yttria-stabilized zirconia powder to form a mixture; dispersing the mixture in a slurry comprising water and a dispersing agent; slip-casting the resulting mixture in a bisqued-body; and sintering the bisqued body resulting in the sintered ceramic body. In some aspects, the iron-containing, yttria-stabilized zirconia ceramic material is in a bisqued state. In other aspects, the iron-containing, yttria-stabilized zirconia ceramic material is a pre-sintered ceramic material. For example, the yttria-stabilized zirconia material can be a pre-sintered ceramic having undesirable properties, wherein the method anneals the pre-sintered ceramic and thus exhibits the properties of the material disclosed herein.

In some aspects of the present disclosure, starting materials are provided such as, but not limited to, a stabilized zirconia powder, a dispersant, and deionized water. In aspects disclosed herein, the yttria-stabilized zirconia powders used as starting materials may optionally comprise a small amount of alumina (aluminum oxide, Al₂O₃) as an additive. In certain aspects, the stabilized zirconia powder include yttria-stabilized zirconia that has been stabilized with greater than 0 mol % yttria to 8 mol % yttria, such as from 2 mol % yttria to 4 mol % yttria, or such as from 4 mol % yttria to 6 mol % yttria. Examples of yttria-stabilized zirconia powders can include, but are not limited to, Tosoh TZ-3YS, Tosoh Zpex4, or Tosoh Zpex® Smile, and the like.

### V. Overview of Several Aspects

Disclosed herein are aspects of a material, comprising: a sintered ceramic comprising iron (III) oxide (Fe₂O₃) and yttria-stabilized zirconia; a distance from a cross-sectional center comprising a core to a perimeter portion of the sintered ceramic ranging from 4 millimeters to 15 millimeters; and (i) a CIELAB a* at the core greater than −2, (ii) a first CIELAB b* at the core of less than or equal to 8 points below a second CIELAB b* at the perimeter portion of the sintered ceramic, (iii) a first CIELAB hue angle (h_{ab}) at the core of less than or equal to 5 degrees greater than a second CIELAB hue angle (h_{ab}) at the perimeter portion; (iv) or any combination of (i), (ii), and/or (iii).

In some aspects of the present disclosure, the sintered ceramic comprises amounts of iron (III) oxide (Fe₂O₃) ranging from greater than 0 wt. % to 0.8 wt. %, based on the total weight of the sintered ceramic.

In any or all of the above aspects of the present disclosure, the sintered ceramic has an yttria content ranging from greater than 0 mol % to 8 mol %.

In any or all of the above aspects of the present disclosure, the material may further comprise a coloring agent selected from erbium, cobalt, manganese, or any combination thereof.

In any or all of the above aspects of the present disclosure, the material may comprise an erbium content ranging from greater than 0 wt. % to 0.55 wt. %, based on the total weight of the sintered ceramic.

In any or all of the above aspects of the present disclosure, the material may comprise a cobalt content ranging from greater than 0 wt. % to 0.005 wt. %, based on the total weight of the sintered ceramic.

In any or all of the above aspects of the present disclosure, the material may comprise a manganese content ranging from ranging from greater than 0 wt. % to 0.0013 wt. % (13 ppm), based on the total weight of the sintered ceramic.

In any or all of the above aspects of the present disclosure, the sintered ceramic comprises amounts of iron (III) oxide (Fe₂O₃) ranging from greater than 0 wt. % to 0.20 wt. %, based on the total weight of the sintered ceramic and the first CIELAB b* at the core of less than or equal to 5 points below the second CIELAB b* at the perimeter portion of the sintered ceramic.

In any or all of the above aspects of the present disclosure, the material further comprises a first CIELAB chroma (C*_{ab}) at the core of less than or equal to 5 points below a second CIELAB chroma (C*_{ab}) at the perimeter portion of the sintered ceramic.

In any or all of the above aspects of the present disclosure, the sintered ceramic comprises amounts of iron (III) oxide (Fe₂O₃) ranging from greater than 0 wt. % to less than 0.20 wt. %, based on the total weight of the sintered ceramic; and (i) the first CIELAB hue angle (h_{ab}) at the core of less than or equal to 4 degrees greater than the second hue angle (h_{ab}) at the perimeter portion of the sintered ceramic; (ii) the first CIELAB chroma (C*_{ab}) at the core of less than or equal to 4 points below the second CIELAB chroma (C*_{ab}) at the perimeter portion of the sintered ceramic; (iii) the first CIELAB b* at the core of less than or equal to 3 points below the second CIELAB b* at the perimeter portion of the sintered ceramic; or (iv) any combination of (i), (ii), and/or (iii).

In any or all of the above aspects of the present disclosure, the sintered ceramic comprises amounts of iron (III) oxide (Fe₂O₃) ranging from greater than 0.10 wt. % to 0.75 wt. %, based on the total weight of the sintered ceramic, and a CIELAB a* at the core greater than 0.

In any or all of the above aspects of the present disclosure, the sintered ceramic comprises a flexural strength of greater than or equal to 800 MPa.

Also disclosed herein is a material, comprising: a sintered ceramic comprising iron (III) oxide (Fe₂O₃) and yttria-stabilized zirconia; a minimum distance from a cross-sectional center comprising a core to a perimeter portion of the sintered ceramic ranging from 5 millimeters to 15 millimeters; and (i) a first CIELAB b* value at the core of at least 20 or greater; (ii) a CIELAB chroma (C*_{ab}) value of 20 or greater at the core; (iii) a CIELAB chroma difference (ΔC*_{ab}) between the perimeter portion and the core ranging from greater than 0 to 16; (iv) a saturation (C*ab/L*) at the core ranging from 0.25 to 0.35; or (v) or any combination of (i), (ii), (iii) and/or (iv).

In any or all of the above aspects of the present disclosure, the ceramic body is stabilized by 3 mol % yttria to 5.3 mol % yttria.

In any or all of the above aspects of the present disclosure, the sintered ceramic body comprises from 0.20 wt. % to 0.50 wt. % iron (III) oxide (Fe₂₀) 3), based on the total weight of the sintered ceramic body.

In any or all of the above aspects of the present disclosure, the sintered ceramic body further comprises greater than 0 wt. % cobalt to 0.001 wt. % cobalt, based on the total weight of the sintered ceramic body.

In any or all of the above aspects of the present disclosure, the sintered ceramic body comprises from 0.20 wt. % to 0.25 wt. % iron (III) oxide (Fe₂O₃), based on the total weight of the sintered ceramic body, and the first CIELAB (C*_{ab}) at the core ranging from greater than 0 points to 10 points below a second CIELAB (C*_{ab}) at the perimeter portion.

In any or all of the above aspects of the present disclosure, the sintered body further comprises a first CIELAB hue angle (h_{ab}) at the core of less than or equal to 4 degrees greater a second CIELAB hue angle (h_{ab}) at the perimeter portion.

In any or all of the above aspects of the present disclosure, the sintered ceramic body is formed by: introducing the iron (III) oxide (Fe₂O₃) via: (i) a pre-integrated yttria-stabilized zirconia powder to form a mixture; (ii) spraying a solution comprising iron (III) nitrate nonahydrate salt in a solvent onto a non-shaded pressable yttria-stabilized zirconia powder to form a mixture; or (iii) mixing the resulting mixture of (ii) with non-shaded yttria-stabilized powder; pressing or casting the resulting mixture into a green block; bisque the green block resulting in a bisqued body; and sintering the bisqued body resulting in the sintered ceramic body.

In any or all of the above aspects of the present disclosure, the sintered ceramic body is formed by: introducing the iron (III) oxide (Fe₂O₃) via: (i) a pre-integrated yttria-stabilized zirconia powder to form a mixture or (ii) mixing an iron (III) oxide (Fe₂O₃) powder with yttria-stabilized zirconia powder to form a mixture; dispersing the mixture in a slurry comprising water and a dispersing agent; slip-casting the resulting mixture in a bisqued-body; and sintering the bisqued body resulting in the sintered ceramic body.

Also disclosed herein is a method for making a sintered ceramic body, comprising: introducing an iron-containing, yttria-stabilized zirconia ceramic material into a furnace; heating the ceramic material in the furnace to a furnace temperature ranging from 1200° C. to 1700° C. for at least 5 minutes; and cooling the ceramic material at a controlled furnace cooling rate ranging from greater than 0° C./minute to 3° C./minute to a temperature ranging from 800° C. to 1200° C.

In any or all of the above aspects of the present disclosure, the iron-containing, yttria-stabilized zirconia ceramic material is in a green state.

In any or all of the above aspects of the present disclosure, the iron-containing, yttria-stabilized zirconia ceramic material is in a bisqued or partially sintered state.

In any or all of the above aspects of the present disclosure, the iron-containing, yttria-stabilized zirconia ceramic material is a sintered ceramic material.

In any or all of the above aspects of the present disclosure, the iron-containing, yttria-stabilized zirconia ceramic material is cooled from a temperature of preferably 1400° C. or greater at a controlled furnace cooling rate of 1° C./minute to a temperature of 900° C.

In any or all of the above aspects of the present disclosure, the iron-containing, yttria-stabilized zirconia ceramic material comprises (i) yttria greater than 2 mol % and less than 7 mol % and (ii) iron (III) oxide (Fe₂O₃) less than 0.30 wt. %.

In any or all of the above aspects of the present disclosure, the minimum distance from a cross-sectional center comprising a core to a perimeter portion of the iron-containing, yttria-stabilized zirconia ceramic material when sintered is less than 15 millimeters.

### VI. Examples

Aspects of the present teachings can be further understood in light of the following examples. Methods of making sintered iron-containing ceramic bodies and sintered iron-containing ceramic bodies disclosed herein were prepared and tested.

In the following examples, sintered ceramic bodies were cooled with a controlled furnace cooling rate of 1° C. per minute and comparator sintered ceramic bodies were cooled with a controlled furnace rate of 11.7° C. per minute to a temperature of 1200° C. Sintered ceramic bodies were produced from iron-containing, yttria-stabilized zirconia material ranging from 0.05 wt. % Fe₂O₃ to 0.75 wt. % Fe₂O₃; greater than 0 mol % yttria to 8 mol % yttria; and/or other coloring agents. Fe₂O₃ was introduced as pre-integrated powder, salt solution sprayed, and/or salt solution sprayed and mixed.

Quantitative examination of the resulting sintered ceramic bodies was investigated by CIE L*a*b* measurements (a perceptual color space for describing a standard observer's perception of shade in a Cartesian 3-space system in which lightness is enumerated by L* and color is described by the combination of a* (red-green) and b* (yellow-blue)) and CIE L*C*h measurements (a color space corresponding to CIE L*a*b*, that exchanges the Cartesian coordinate system for a cylindrical one in which L* remains the same descriptor while color is instead described as the combination of h or angle describing the hue and C* being the chroma or degree of saturation of the particular hue), wherein C* can be calculated from a* and b* vectors. CIE L*a*b*and CIE L*C*h measurements of the outer skin and sectioned core of thick sintered samples taken using SpectroShade Micro II. For each material and sinter condition, the scan images of the skin and core faces were extracted and arranged for qualitative comparison with one another and with those of other sinter conditions and materials. CIELAB color space metrics and differences discussed herein are based on CIE standard illuminant D65 and the CIE 1931 (2°) standard colorimetric observer (basis of the CIELAB measurements using SpectroShade Micro II Imaging Spectrophotometer).

CIELAB color space measurements were performed on samples of suitable thickness to exhibit intrinsic color (considered to be semi-infinitely thick from an optical standpoint).

CIELAB correlates of chroma and hue, per CIE 15:2004 Colorimetry.

CIELAB chroma (C*_{ab}):

$${C}_{a b}^{*} = \sqrt{{a}^{* 2} + {b}^{* 2}} \qquad Equation 1$$

CIELAB hue angle (h_{ab}):

$${h}_{a b} = {tan}^{- 1} ( {b}^{*} / {a}^{*} ) \qquad Equation 2$$

CIELAB differences between two color stimuli (denoted by subscripts 1 and 0), per CIE 15:2004 Colorimetry for CIELAB color difference (ΔE*_{ab}) is represented by Equation 3; and the CIELAB chroma difference (ΔC*_{ab}) represented by Equation 4; and CIELAB hue angle difference (Δh_{ab}) is represented by Equation 5 shown below.

CIELAB color difference (ΔE*_{ab}):

$$Δ {E}_{a b}^{*} = \sqrt{{( Δ {L}^{*} )}^{2} + {( Δ {a}^{*} )}^{2} + {( Δ {b}^{*} )}^{2}} \qquad Equation 3$$

CIELAB chroma difference (ΔC*_{ab}):

$$Δ {C}_{a b}^{*} = {C}_{a b , 1}^{*} - {C}_{a b , 0}^{*} \qquad Equation 4$$

CIELAB hue angle difference (Δh_{ab}):

$$Δ {h}_{a b} = {h}_{a b , 1} - {h}_{a b , 0} \qquad Equation 5$$

“Skin” and/or “perimeter” of the sintered body refers to the immediate subsurface. The samples investigated were mounted and polished—removing the immediate surface and revealing the subsurface. Samples that were not polished had their “skin” measurements and evaluations made on points of their cross-sectioned areas not more than 0.5 mm from the edge. As such, the “skin” and “perimeter” of the sintered body refers to the immediate subsurface of fully sintered bodies.

Saturation is the colorfulness of an area judged in proportion to its brightness and since chroma is colorfulness as a proportion of the brightness of similarly illuminated achromatic area (white) and since lightness is brightness judged as a proportion of the brightness of a similarly illuminated achromatic area (white), saturation can also be a description of the chroma of an area judged in proportion to its lightness, and thus the correlate can be represented by Equation 6 shown below.

$$\frac{{C}_{a b}^{*}}{{L}^{*}} \qquad Equation 6$$

FIG. 1 is an illustration demonstrating the preparation of cylindrical sintered ceramic bodies for CIE L*a*b*and CIE L*C*h measurements. The cylindrical sintered ceramic blocks were partitioned in half along the longitudinal axis and partitioned at a region of maximum discoloration to produce a first core, skin, and second core. The first core, skin, and second core were then mounted, polished, and scanned by using a calibrated SpectroShade Micro II Imaging Spectrometer to collect the CIE L*a*b*and CIE L*C*h measurements from the center of the complete core face and on portion of the skin with a cursor size 40 (corresponds to an area of approximately 1.15×1.15 millimeters). FIG. 2 is an illustration demonstrating preparation of rectangular sintered ceramic bodies for CIE L*a*b*and CIE L*C*h measurements. The rectangular blocks were sectioned in half, orthogonal to the greatest length. An as-fired face and an exposed core section face were each mounted, polished, and scanned using a calibrated SpectroShade Micro II Imaging Spectrometer to collect the CIE L*a*b*and CIE L*C*h measurements from the center of the skin face and core face respectively with a cursor size 40.

Long, rectangular sintered ceramic blocks were partitioned in half to expose the core. From one half of each sectioned sample, multispectral imaging scans were collected using a calibrated SpectroShade Micro II Imaging Spectrophotometer by scanning the bottom portion (i.e., face in contact with the crucible during sintering), middle portion, and top portion of the sectioned face.

SpectroShade Analysis software was used to collect CIE L*a*b* measurements from an area at a center portion of the Mid scan of each sample face with cursor size 40 (corresponds to an area of approximately 1.15×1.15 millimeters) representative of the core as well as measurements no deeper than 0.5 millimeters from a discernable sample edge of one of the scans of each sample with cursor size 4 (corresponds to an area of approximately 0.11×0.11 millimeters) representative of the skin. C* chroma was calculated from the a* and b* values for each image. The C* values of the skin and core faces of each material and sinter condition were compared to one another to quantify the degree of color saturation or retention at the core depth of each sample relative to the skin/surface.

ΔE comparisons between the skin and core of the sintered ceramic body indicates the magnitude of perceivable difference in shade expressed between skin and core. ΔC* chroma of the skin and core indicates the magnitude of perceivable desaturation at the core of the sintered ceramic body.

### Example 1

In this example, a ceramic body comprising 4 mol. % yttria and 0.20 wt. % Fe₂O₃ was produced with a controlled furnace cooling rate of 1° C./minute to a temperature of 900° C. (Article 2) as shown in Table 1 and compared to a comparator ceramic body comprising 4 mol. % yttria, 0.20 wt. % Fe₂O₃, which was produced with a controlled cooling rate of 11.7° C./minute to a temperature of 1200° C. (Comparator Article 3) as shown in Table 1.

TABLE 1

| Name | Step | Operation |
|---|---|---|
| Article 2 | 1 | Ramp from room temperature to 900° C. in at |
| | | 7.3° C./minute |
| | 2 | Ramp up from 900° C. to 1200° C. at |
| | | 1° C./minute |
| | 3 | Hold at 1200° C. for 240 minutes |
| | 4 | Ramp up from 1200° C. to 1550° C. at |
| | | 0.5° C./minute |
| | 5 | Hold at 1550° C. for 120 minutes |
| | 6 | Cool from 1550° C. to 900° C. at 1° C./minute |
| | 7 | Cool from 900° C. to room temperature at |
| | | 14.6° C./minute |
| | 8 | Turn off furnace |
| Comparator | 1 | Ramp from room temperature to 900° C. in |
| | | at 7.3° C./minute |
| Article 3 | 2 | Ramp up from 900° C. to 1200° C. at |
| | | 1° C./minute |
| | 3 | Hold at 1200° C. for 240 minutes |
| | 4 | Ramp up from 1200° C. to 1550° C. at |
| | | 0.5° C./minute |
| | 5 | Hold at 1550° C. for 120 minutes |
| | 6 | Cool from 1550° C. to 900° C. at |
| | | 11.7° C./minute |
| | 7 | Cool from 1200° C. to 155° C. at |
| | | 14.9° C./minute |
| | 8 | Turn off furnace |

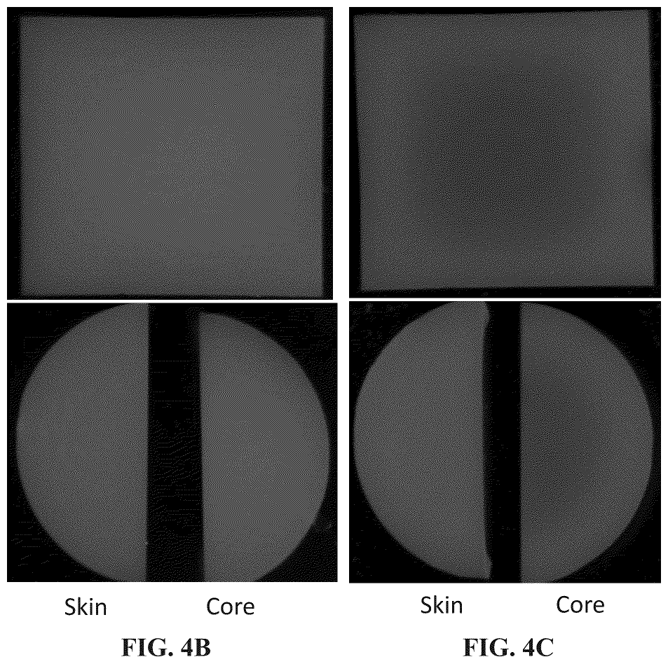

FIG. 4A shows the temperature profiles of Article 2 and Comparator Article 3, demonstrating a slower cooling rate and cool-to temperature (900° C. vs 1200° C.) for Article 2 comprising a controlled furnace cooling rate of 1° C./minute than Comparator Article 3 comprising a faster controlled furnace cooling rate of 11.7° C./minute. FIG. 4B is an image of the sintered ceramic body (Article 2) comprising 4 mol. % yttria and 0.20 wt. % Fe₂O₃ produced according to temperature profile BEP-5 shown in FIG. 4A. FIG. 4C is an image of the sintered ceramic body (Comparator Article 3) produced according to temperature profile BEP-6 shown in FIG. 4A. In view of FIG. 4B, BEP-5 profile with a controlled furnace cooling rate of 1° C./minute cooled from a peak of 1550° C. to 900° C. did not exhibit gray-green core discoloration. Moreover, BEP-5 had a ΔE between the skin and the core of 2.05. In contrast, as shown by FIG. 4C, BEP-6 profile with a controlled furnace cooling rate of 11.7° C./minute from a peak of 1550° C. to 1200° C. exhibited gray-green core discoloration and a ΔE between the skin and the core of 16.97. Therefore, this example demonstrated greater agreement throughout the volume of a sintered ceramic body that was cooled via a controlled furnace cooling rate of 1° C./minute than a sintered ceramic body generated with a controlled furnace cooling rate of 11.7° C./minute.

### Example 2

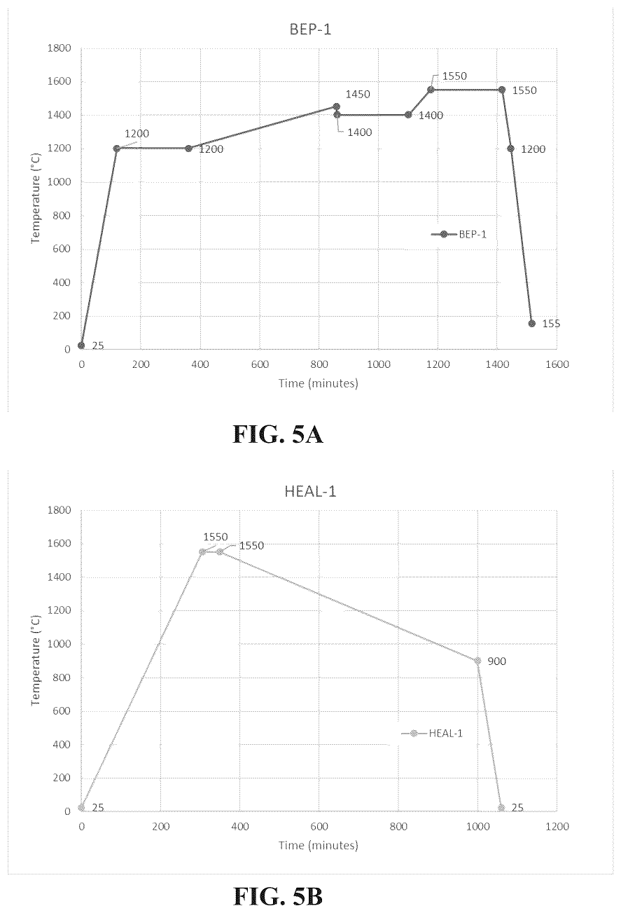

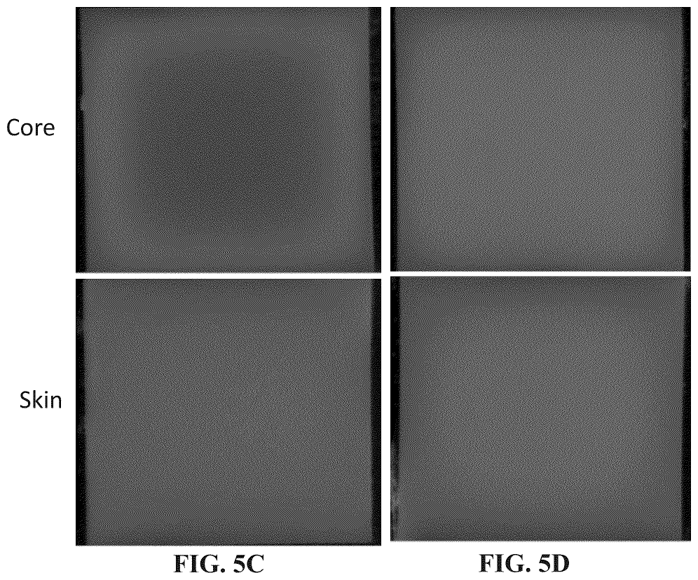

In this example, the sintered block produced with a controlled furnace cooling rate of 11.7° C./minute having the temperature profile of FIG. 5A was re-worked with an additional annealing step comprising a controlled furnace cooling rate of 1° C./minute to a temperature of 900° C. depicted in the temperature profile of FIG. 5B. The annealing cycle was then investigated by subjecting the originally sintered block with a controlled furnace cooling rate of 11.7° C./minute to an annealing cycle comprising the temperature profile of FIG. 5B comprising heating at a rate of 5° C./min to 1550° C.; maintaining the temperature at 1550° C. for 45 minutes; followed by a controlled furnace cooling rate of 1° C./min down to 900° C. FIG. 5C is an image of the skin and core of the pre-annealed ceramic block, which demonstrates discoloration at the core and a ΔE of 18.10. In contrast, FIG. 5D is an image of the annealed ceramic body comprising less color discoloration relative to FIG. 5C; and the annealed ceramic body exhibited a ΔE of 1.08.

Accordingly, the annealing cycle reduced the discoloration of a sintered ceramic block that was first sintered to a profile with a controlled furnace cooling rate of 11.7° C./minute. Therefore, aspects of the method disclosed herein can be used to reduce discoloration and subsurface desaturation in sintered ceramic bodies.

### Example 3

In this example, ceramic bodies comprising lower concentrations of Fe₂O₃ and other colorants using the aspects of the method disclosed herein were investigated. Ceramic bodies were sintered and cooled with a controlled furnace cooling rate of 1° C./minute from the peak sinter temperature of 1550° C. to 900° C. For comparison, comparator ceramic bodies were sintered cooled at a controlled furnace cooling rate of 11.7° C./minute from the peak sinter temperature of 1550° C. to 1200° C. (referred to herein as “comparator article”). Table 2 shows the concentrations of Fe₂O₃, cobalt (Co), and erbium (Er) for the sintered ceramic bodies produced with a controlled furnace cooling rate of 1° C./minute and of the comparator articles produced with a controlled furnace cooling rate of 11.7° C./minute.

TABLE 2

| | | | | Comparator |
|---|---|---|---|---|
| | | | Article # | Article # |
| Fe₂O₃ | Co | Er | (Cooling Rate: | (Cooling Rate: |
| (wt. %) | (wt. %) | (wt. %) | 1° C./min) | 11.7° C./min) |
| 0.06 | 0.001 | 0.13 | Article 51 | — |
| 0.06 | 0 | 0.16 | Article 46 | — |
| 0.08 | 0.001 | 0.25 | Article 47 | — |
| 0.08 | 0.003 | 0.06 | Article 53 | — |
| 0.08 | 0.004 | 0.13 | Article 56 | — |
| 0.1 | 0.001 | 0.17 | Article 52 | Comparator Article 43 |
| 0.11 | 0.001 | 0.31 | Article 48 | Comparator Article 41 |
| 0.11 | 0.004 | 0.13 | Article 54 | Comparator Article 44 |
| 0.12 | 0.004 | 0.25 | — | Comparator Article 45 |
| 0.13 | 0.001 | 0.42 | Article 49 | Comparator Article 42 |
| 0.14 | 0.005 | 0.03 | Article 55 | — |
| 0.16 | 0.002 | 0.54 | Article 50 | — |
| 0.2 | 0 | 0 | Article 39 | Comparator Article 1 |

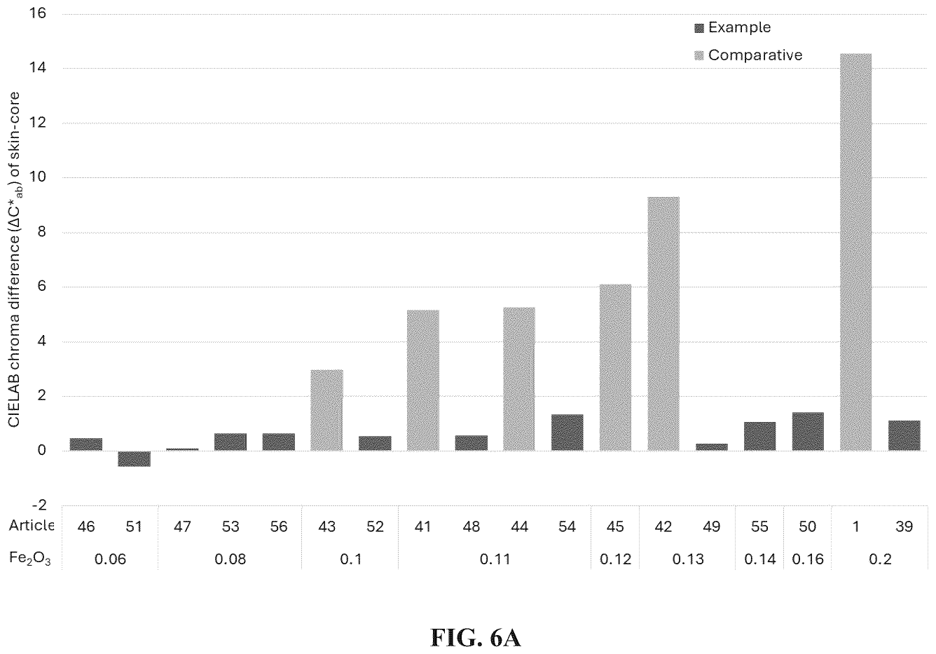

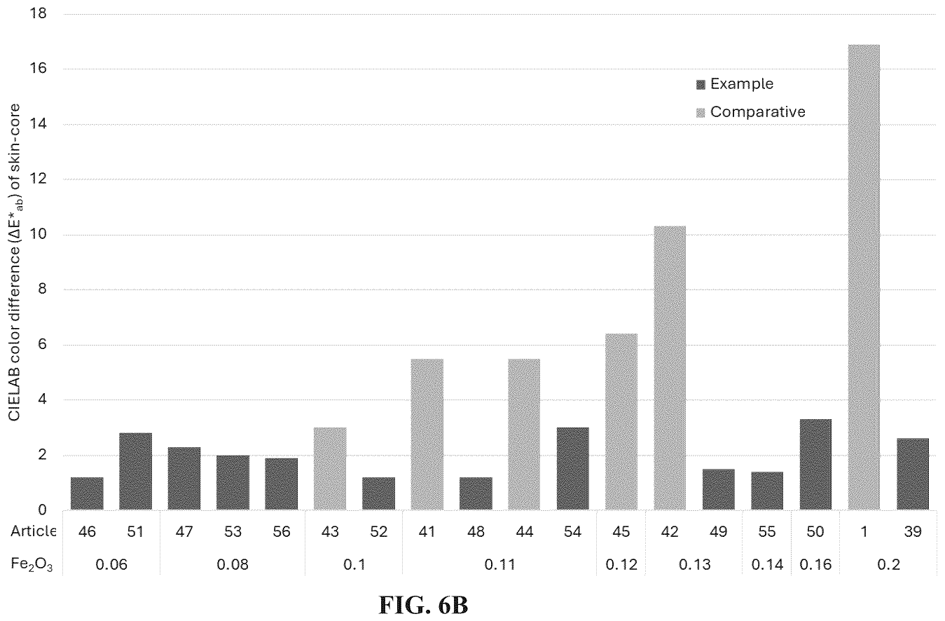

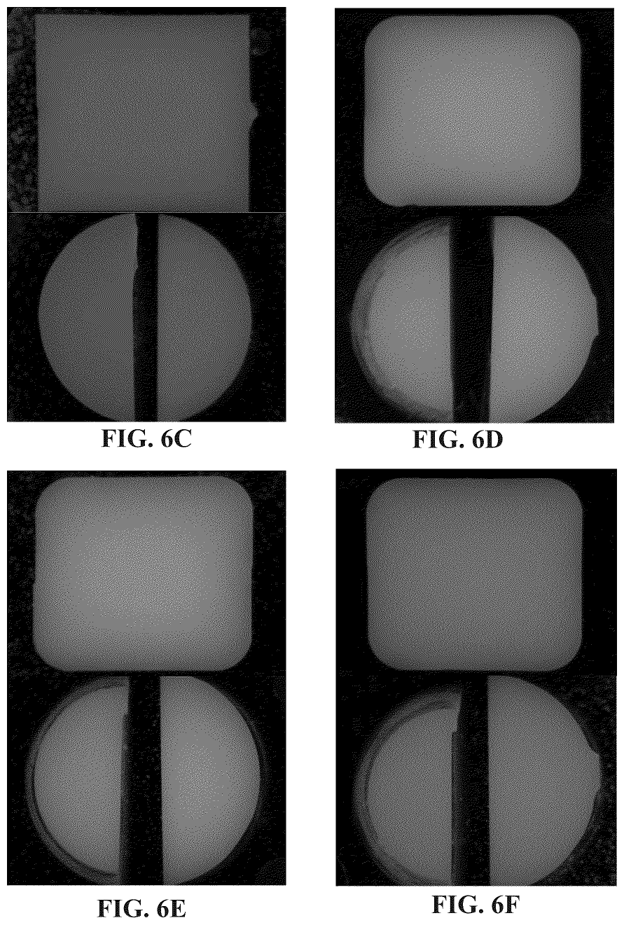

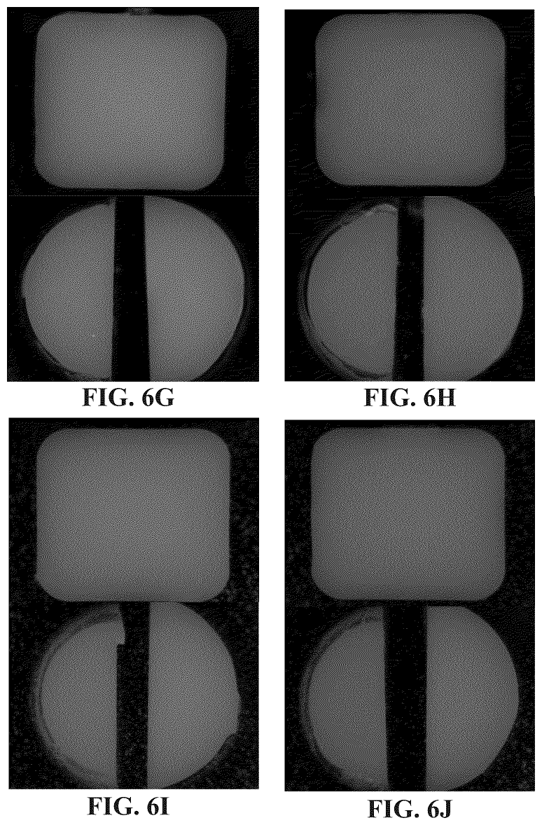

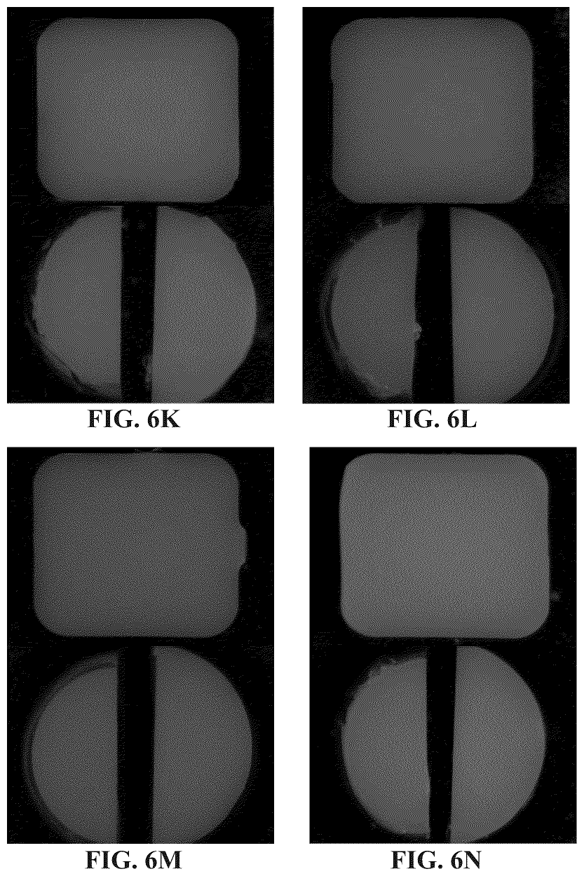

FIG. 6A is a bar graph showing the discrepancy in chroma between the skin and core (AC*ab of skin-core) of the sintered ceramic bodies generated using a controlled furnace cooling rate of 1° C./minute down to 900° C. versus the comparator articles. FIG. 6B is a bar graph showing the perceptual color difference (ΔE*_{ab}) between the perimeter and core of each article the sintered ceramic bodies generated using a controlled furnace cooling rate of 1° C./minute down to 900° C. versus the comparator articles. Table 3 shows the properties of resulting sintered ceramic bodies and of the comparator articles produced with a controlled furnace cooling rate of 11.7° C./minute.

TABLE 3

| 1° C./minute (Cooling Rate) | | | | 11.7° C./minute (Cooling Rate) | | | |
|---|---|---|---|---|---|---|---|
| 900° C. (Cool-to Temperature) | | | | 1200° C. (Cool-to Temperature) | | | |
| | Gray-Green | Skin- | Skin- | | Gray-Green | Skin- | Skin- |
| Article | Core | Core | Core | Comparator | Core | Core | Core |
| # | Discoloration | ΔE | ΔC | Article # | Discoloration | ΔE | ΔC |
| 51 | No | 2.8 | −0.58 | — | — | — | — |
| 46 | No | 1.2 | 0.46 | — | — | — | — |
| 47 | No | 2.3 | 0.1 | — | — | — | — |
| 53 | No | 2 | 0.63 | — | — | — | — |
| 56 | No | 1.9 | 0.64 | — | — | — | — |
| 52 | No | 1.2 | 0.54 | 43 | No | 3 | 2.97 |
| 48 | No | 1.2 | 0.56 | 41 | Low | 5.5 | 5.15 |
| 54 | No | 3 | 1.33 | 44 | Low | 5.5 | 5.26 |
| — | — | — | — | 45 | Low | 6.4 | 6.11 |
| 49 | No | 1.5 | 0.27 | 42 | Yes | 10.3 | 9.31 |
| 55 | No | 1.4 | 1.07 | — | — | — | — |
| 50 | No | 3.3 | 1.4 | — | — | — | — |
| 39 | No | 2.6 | 1.11 | 1 | Yes | 16.9 | 14.54 |

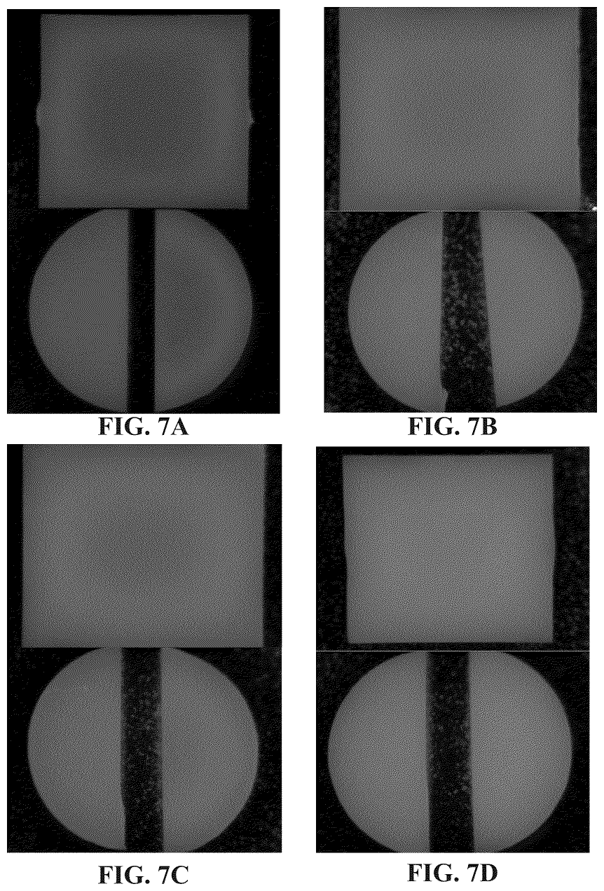

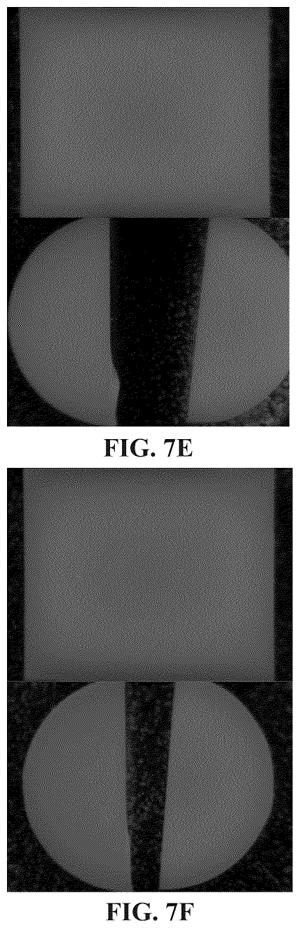

FIG. 6A demonstrates that C* at the core is lower than that of the skin for the majority of articles. The distinction between the articles and the comparator articles is that the articles exhibited greater consistency in C* (less of a drop) in C* from skin to core relative to the comparator articles. While the difference in C* between the skin and core increases with increasing Fe₂O₃ content for comparators, the articles demonstrated greater consistency. Furthermore, in view of Table 3 and FIGS. 6A-6B, the sintered ceramic bodies cooled using a controlled furnace cooling rate of 1° C./minute yielded a CIE L*C*h difference in C* chroma (ΔC*_{ab}) of less than 2 between a perimeter and a cross-sectional center of the sintered ceramic body and CIELAB color difference (ΔE*_{ab}) of less than 3.5 between a perimeter and a cross-sectional center of the sintered ceramic body. FIGS. 6C-6N are images of the sintered ceramic bodies that were cooled using a controlled furnace cooling rate of 1° C./minute exhibited no discoloration and measurable uniform shade consistency. In contrast, as shown in Table 3 comparator articles yielded greater differences in chroma between the skin and core with the core having notably lower chroma expression relative to that of the skin. In view of FIGS. 7A-7F, which are images of the comparator articles, show a greater change in shade between skin and core in addition to the observable core discoloration.

Accordingly, this example demonstrates that ceramic bodies produced with a controlled cooling rate of 1° C./minute to a temperature of 900° C. exhibited a ΔE*_{ab} (skin-core) below 3.5 and desirable coloration between the skin and core; whereas the comparator articles cooled from a sinter temperature down to 1200° C. at a rate of 11.7° C./minute yielded greater change in shade between the skin and core in addition to the observed core discoloration.

### Example 4

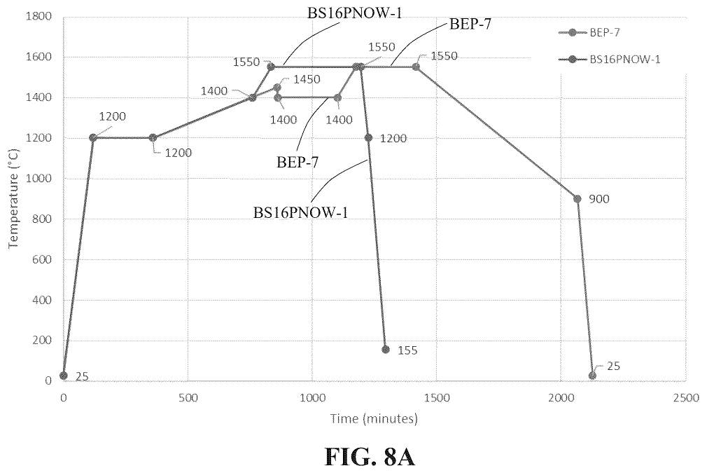

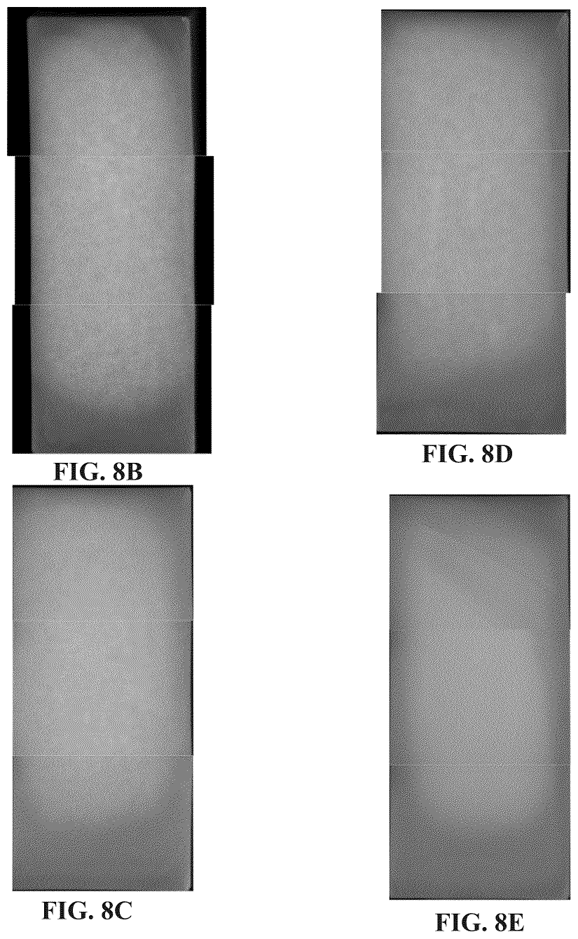

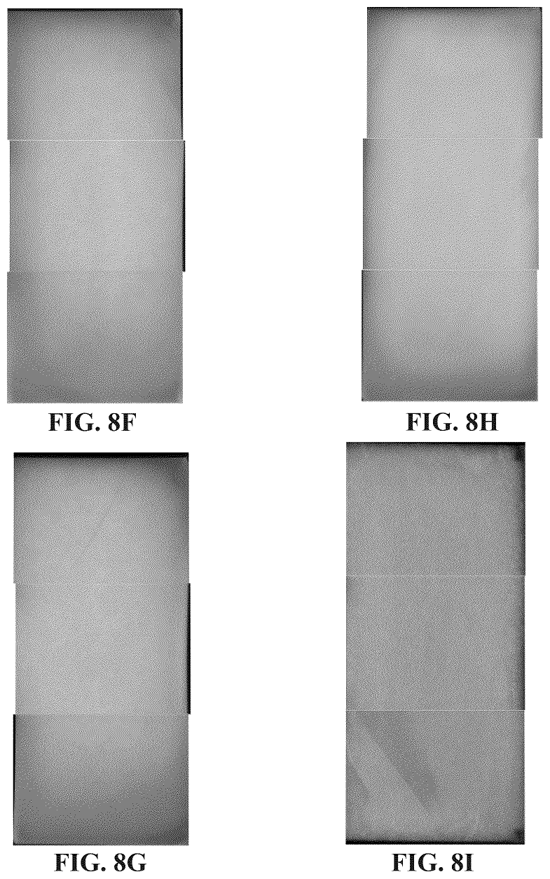

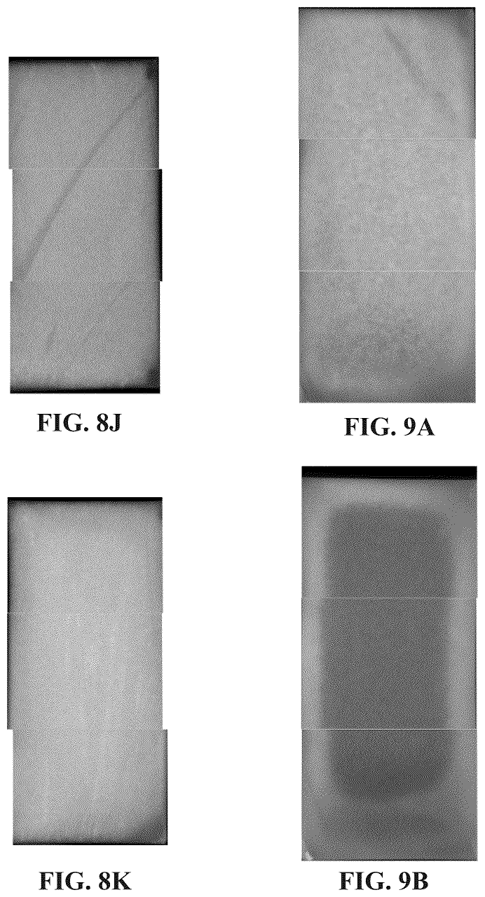

In this example, ceramic bodies comprising varying yttria and Fe₂O₃ contents using the aspects of the method disclosed herein were investigated. Ceramic bodies were sintered and cooled with a controlled furnace cooling rate of 1° C./minute from the peak sinter temperature of 1550° C. to 900° C. and compared to the comparator articles. FIG. 8A is a line graph (temperature v. time) showing the temperature profile comprising a controlled furnace cooling rate of 1° C./minute from the peak sinter temperature of 1550° C. to 900° C. and the comparator temperature profile comprising a controlled furnace cooling rate of 11.7° C./minute from the peak sinter temperature of 1550° C. to 1200° C. FIG. 8A is a line graph (temperature v. time) showing the temperature profile comprising a controlled furnace cooling rate of 1° C./minute from the peak sinter temperature of 1550° C. to 900° C. and the comparator temperature profile comprising a controlled furnace cooling rate of 11.7° C./minute from the peak sinter temperature of 1550° C. to 1200° C. Table 4 shows the compositions of the sintered ceramic bodies and of the comparator articles.

TABLE 4

| | | Article # | |
|---|---|---|---|
| | | 1° C./min | |
| | | (Cooling Rate) | Comparator Article # |
| Composition | | 900° C. | 11.7° C./min (Cooling Rate) |
| Fe₂O₃ | Yttria | (Cool-to Temp.) | 1200° C. (Cool-to Temp.) |
| (wt. %) | (mol %) | Article | Comparator Article |
| 0.2 | 3 | 27 | 26 |
| 0.2 | 4 | 25 | 24 |
| 0.2 | 4 | 35 | 34 |
| 0.2 | 4 | 17 | 16 |
| 0.2 | 5.3 | 29 | 28 |
| 0.25 | 5.3 | 31 | 30 |
| 0.25 | 5.3 | 19 | 18 |
| 0.5 | 3 | 21 | 20 |
| 0.5 | 4 | 33 | 32 |
| 0.5 | 5.3 | 23 | 22 |

FIGS. 8B-8K are images of sectioned rectangular comparator sintered ceramic blocks sectioned in half to expose a core, wherein the section face comprising the exposed core comprises a top portion, a mid-portion, and a bottom portion as illustrated by FIG. 3. FIG. 8B is an image of the core of a sintered ceramic body (Article 27) cooled with a controlled furnace cooling rate of 1° C./minute to a temperature of 900° C. exhibiting a core C* chroma of 24.83 units; a ΔC* (skin-core) of 4.72 units; and showing no gray-green core discoloration. FIG. 8C is an image of the core of a sintered ceramic body (Article 25) cooled with a controlled furnace cooling rate of 1° C./minute to a temperature of 900° C. exhibiting a core C* chroma of 24.88 units; a ΔC* (skin-core) of 3.91 units; and showing no gray-green core discoloration. FIG. 8D is an image of the core of a sintered ceramic body (Article 35) cooled with a controlled furnace cooling rate of 1° C./minute to a temperature of 900° C. exhibiting a core C* chroma of 25.17 units; a ΔC* (skin-core) of 4.5 units; and showing no gray-green core discoloration. FIG. 8E is an image of the core of a sintered ceramic body (Article 17) cooled with a controlled furnace cooling rate of 1° C./minute to a temperature of 900° C. exhibiting a core C* chroma of 25.94 units; a ΔC* (skin-core) of 5.64 units; and showing no gray-green core discoloration. FIG. 8F is an image of the core of a sintered ceramic body (Article 29) cooled with a controlled furnace cooling rate of 1° C./minute to a temperature of 900° C. exhibiting a core C* chroma of 23.86 units; a ΔC* (skin-core) of 2.51 units; and showing no gray-green core discoloration.

FIG. 8G is an image of the core of a sintered ceramic body (Article 31) cooled with a controlled furnace cooling rate of 1° C./minute to a temperature of 900° C. exhibiting a core C* chroma of 24.03 units; a ΔC* (skin-core) of 4.17 units; and showing no gray-green core discoloration. FIG. 8H is an image of the core of a sintered ceramic body (Article 19) cooled with a controlled furnace cooling rate of 1° C./minute to a temperature of 900° C. exhibiting a core C* chroma of 22.83 units; a ΔC* (skin-core) of 6.96 units; and showing no gray-green core discoloration. FIG. 8I is an image of the core of a sintered ceramic body (Article 21) cooled with a controlled furnace cooling rate of 1° C./minute to a temperature of 900° C. exhibiting a core C* chroma of 22.83 units; a ΔC* (skin-core) of 10.84 units; and showing no gray-green core discoloration. FIG. 8J is an image of the core of a sintered ceramic body (Article 33) cooled with a controlled furnace cooling rate of 1° C./minute to a temperature of 900° C. exhibiting a core C* chroma of 23.5 units; a ΔC* (skin-core) of 13.95 units; and showing no gray-green core discoloration. FIG. 8K is an image of the core of a sintered ceramic body (Article 23) cooled with a controlled furnace cooling rate of 1° C./minute to a temperature of 900° C. exhibiting a core C* chroma of 21.82 units; a ΔC* (skin-core) of 16.23 units; and showing no gray-green core discoloration.

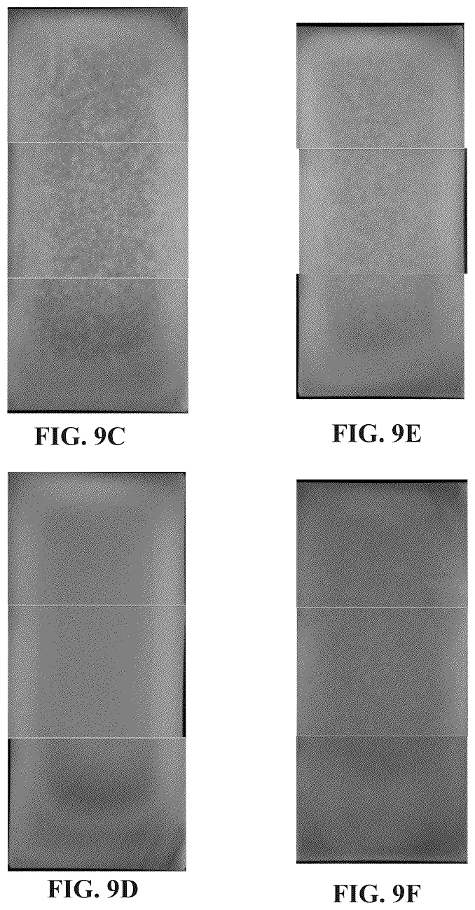

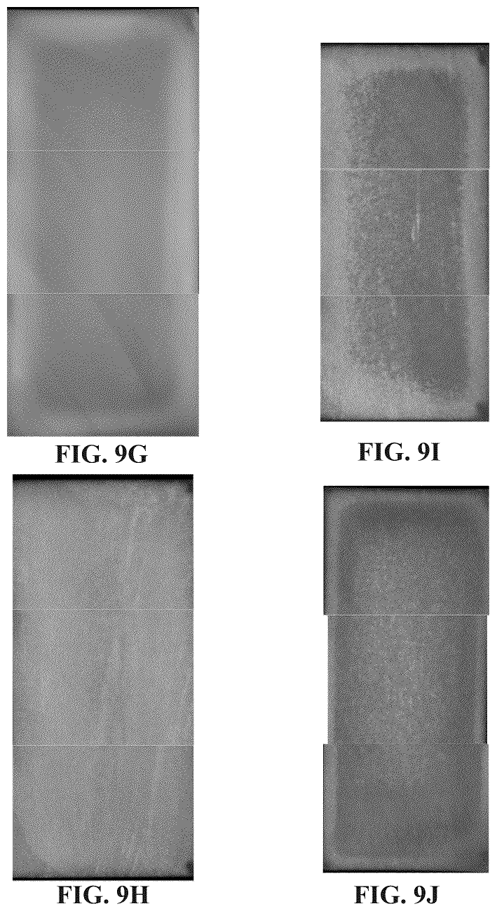

FIGS. 9A-9J are images of sectioned rectangular comparator sintered ceramic blocks sectioned in half to expose a core, wherein the section face comprising the exposed core comprises a top portion, a mid-portion, and a bottom portion as illustrated by FIG. 3. FIG. 9A is an image of the core of a comparator sintered ceramic body (Comparator Article 26) cooled with a controlled furnace cooling rate of 11.7° C./minute to a temperature of 1200° C. exhibiting a core C* chroma of 15.49 units; a ΔC* (skin-core) of 13.65 units; and showing gray-green core discoloration. FIG. 9B is an image of the core of a comparator sintered ceramic body (Comparator Article 24) cooled with a controlled furnace cooling rate of 11.7° C./minute to a temperature of 1200° C. exhibiting a core C* chroma of 5.52 units; a ΔC* (skin-core) of 21.08 units; and showing gray-green core discoloration. FIG. 9C is an image of the core of a comparator sintered ceramic body (Comparator Article 34) cooled with a controlled furnace cooling rate of 11.7° C./minute to a temperature of 1200° C. exhibiting a core C* chroma of 12.2 units; a ΔC* (skin-core) of 15.77 units; and showing gray-green core discoloration. FIG. 9D is an image of the core of a comparator sintered ceramic body (Comparator Article 16) cooled with a controlled furnace cooling rate of 11.7° C./minute to a temperature of 1200° C. exhibiting a core C* chroma of 10.38 units; a ΔC* (skin-core) of 16.02 units; and showing gray-green core discoloration. FIG. 9E is an image of the core of a comparator sintered ceramic body (Comparator Article 28) cooled with a controlled furnace cooling rate of 11.7° C./minute to a temperature of 1200° C. exhibiting a core C* chroma of 14.23 units; a ΔC* (skin-core) of 10.22 units; and showing gray-green core discoloration.

FIG. 9F is an image of the core of a comparator sintered ceramic body (Comparator Article 30) cooled with a controlled furnace cooling rate of 11.7° C./minute to a temperature of 1200° C. exhibiting a core C* chroma of 14.57 units; a ΔC* (skin-core) of 11.87 units; and showing gray-green core discoloration. FIG. 9G is an image of the core of a comparator sintered ceramic body (Comparator Article 18) cooled with a controlled furnace cooling rate of 11.7° C./minute to a temperature of 1200° C. exhibiting a core C* chroma of 13.48 units; a ΔC* (skin-core) of 10.41 units; and showing gray-green core discoloration. FIG. 9H is in an image of the core of a comparator sintered ceramic body (Comparator Article 20) cooled with a controlled furnace cooling rate of 11.7° C./minute to a temperature of 1200° C. exhibiting a core C* chroma of 17.56 units; a ΔC* (skin-core) of 13.04 units; and showing gray-green core discoloration. FIG. 9I is an image of the core of a comparator sintered ceramic body (Comparator Article 32) cooled with a controlled furnace cooling rate of 11.7° C./minute to a temperature of 1200° C. exhibiting a core C* chroma of 11.83 units; a ΔC* (skin-core) of 24.92 units; and showing gray-green core discoloration. FIG. 9J is an image of the core of a comparator sintered ceramic body (Comparator Article 22) cooled with a controlled furnace cooling rate of 11.7° C./minute to a temperature of 1200° C. exhibiting a core C* chroma of 12.17 units; a ΔC* (skin-core) of 20.64 units; and showing gray-green core discoloration.

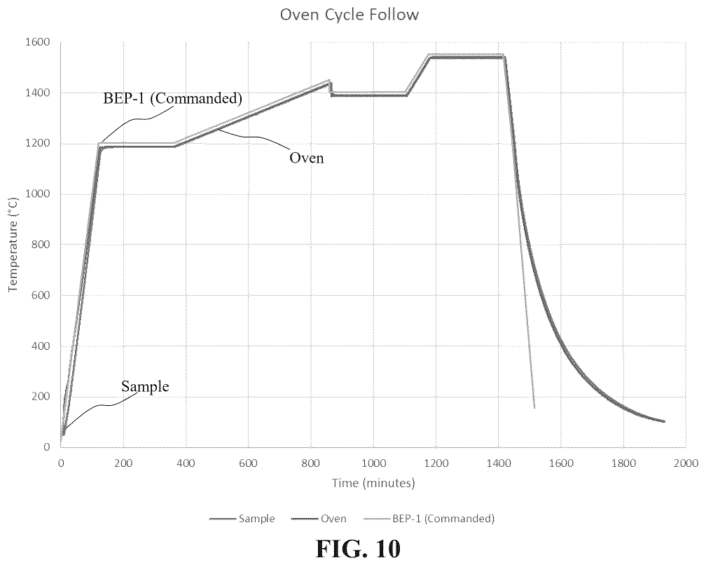

Additionally, the temperature of the ceramic material during sintering was investigated in this example by measuring the furnace temperature and the temperature of a thermocouple embedded in the ceramic material. FIG. 10 is a line graph (temperature v. time) showing a temperature profile of an aspect of the method disclosed herein comparing the temperature of the furnace versus the temperature of a thermocouple embedded in ceramic material.

TABLE 5

| Name | Step | Operation |
|---|---|---|
| BEP-1 | 1 | Ramp from room temperature to 1200° C. at |
| | | 9.8° C./minute |
| | 2 | Hold at 1200° C. for 240 minutes |
| | 3 | Ramp up from 1200° C. to 1450° C. at |
| | | 0.5° C./minute |
| | 4 | Cool from 1450° C. to 1400° C. at |
| | | 50° C./minute |
| | 5 | Hold at 1400° C. for 240 minutes |
| | 6 | Ramp up from 1400° C. to 1550° C. at |
| | | 2° C./minute |
| | 7 | Hold at 1550° C. for 240 minutes |
| | 8 | Cool from 1550° C. to 1200° C. at |
| | | 11.7° C./minute |
| | 9 | Cool from 1200° C. to 155° C. at |
| | | 14.9° C./minute |
| | 10 | Turn off furnace |

Accordingly, the furnace temperature and thermocouple temperature closely track with the temperature profile. The furnace and thermocouple temperature results were compared with the temperature profile shown in Table 5.

### Example 5

In this example, slip-cast ceramic bodies (Articles/Comparator Articles 59-64) produced from slurries comprising yttria (3 mol %, 8 mol %), Fe₂O₃, and a dispersant (Dolapix CE64) after firing were investigated in addition to the remaining Articles/Comparator Articles produced by pressing binder-containing powders. The sintered bodies were cooled at a cooling rate of 1° C./min to a temperature of 900° C. and were compared to sintered bodies cooled with a cooling rate of 11.7° C./min to a temperature of 1200° C. (Comparator Articles). Table 6 shows the compositions of the sintered ceramic bodies and the corresponding CIELAB a* of the core, Δb* (skin-core), Ahab (core-skin), and ΔC (skin-core). Articles 75-76 are blocks of the larger block Articles 24-25 (see Example 6) cut to smaller sizes prior to sintering.

TABLE 6

| | | | | | Gray-Green | | Δb* | Δh_{ab} | ΔC |
|---|---|---|---|---|---|---|---|---|---|
| | Yttria | Fe₂O₃ | Er | Co | Core | Core | (skin- | (core- | (skin- |
| Article | (mol %) | (wt. %) | (wt. %) | (wt. %) | Discoloration | a* | core) | skin) | core) |
| Comparator Article 41 | 3.9 | 0.11 | 0.31 | 0.001 | Slight | −0.32 | 5.14 | 3.26 | 5.15 |
| Comparator Article 42 | 3.8 | 0.13 | 0.42 | 0.001 | Yes | −0.96 | 9.22 | 9.54 | 9.31 |
| Comparator Article 43 | 4 | 0.1 | 0.17 | 0.001 | No | −0.03 | 2.97 | 0.37 | 2.97 |
| Comparator Article 44 | 3.9 | 0.11 | 0.13 | 0.004 | Slight | −0.52 | 5.23 | 5.72 | 5.26 |
| Comparator Article 45 | 3.8 | 0.12 | 0.25 | 0.004 | Slight | 0.12 | 5.95 | 6.61 | 6.11 |
| Comparator Article 59 | 3 | 0.72 | 0 | 0 | Yes | −1.41 | 14.67 | 19.64 | 15.59 |
| Comparator Article 61 | 8 | 0.72 | 0 | 0 | Yes | −1.4 | 6.50 | 0.96 | 6.48 |
| Comparator Article 63 | 5 | 0.72 | 0 | 0 | Yes | −2.27 | 10.49 | 10.58 | 10.4 |
| Comparator Article 75 | 4 | 0.2 | 0 | 0 | Yes | −2.25 | 15.71 | 12.02 | 15.53 |
| Comparator Article 1 | 4 | 0.2 | 0 | 0 | Yes | −4.15 | 15.05 | 17.96 | 14.54 |
| Article 46 | 4 | 0.06 | 0.16 | 0 | No | −1.38 | 0.43 | −0.81 | 0.46 |
| Article 47 | 3.9 | 0.08 | 0.25 | 0.001 | No | 0.26 | 0.10 | −1.78 | 0.1 |
| Article 48 | 3.9 | 0.11 | 0.31 | 0.001 | No | 1.23 | 0.56 | 0.20 | 0.56 |
| Article 49 | 3.8 | 0.13 | 0.42 | 0.001 | No | 2.1 | 0.30 | −0.71 | 0.27 |
| Article 50 | 3.7 | 0.16 | 0.54 | 0.002 | No | 2.54 | 1.35 | 0.73 | 1.4 |
| Article 51 | 4 | 0.06 | 0.13 | 0.001 | No | −1.82 | −0.63 | −1.77 | −0.58 |
| Article 52 | 4 | 0.1 | 0.17 | 0.001 | No | 1.04 | 0.56 | −1.62 | 0.54 |
| Article 53 | 3.9 | 0.08 | 0.06 | 0.003 | No | −0.3 | 0.62 | −0.75 | 0.63 |
| Article 54 | 3.9 | 0.11 | 0.13 | 0.004 | No | 0.74 | 1.32 | 0.36 | 1.33 |
| Article 55 | 3.9 | 0.14 | 0.03 | 0.005 | No | 1.78 | 1.04 | 0.56 | 1.07 |
| Article 56 | 3.9 | 0.08 | 0.13 | 0.004 | No | 0.38 | 0.64 | −0.89 | 0.64 |
| Article 60 | 3 | 0.72 | 0 | 0 | No | 9.49 | 1.26 | 1.73 | 1.65 |
| Article 62 | 8 | 0.72 | 0 | 0 | Slight | 0.28 | 6.98 | 4.11 | 7.1 |
| Article 64 | 5 | 0.72 | 0 | 0 | Slight | 5.57 | 2.51 | 3.18 | 2.95 |
| Article 76 | 4 | 0.2 | 0 | 0 | No | 3.55 | 3.32 | 2.02 | 3.5 |
| Article 39 | 4 | 0.2 | 0 | 0 | No | 3.11 | 1.09 | 0.30 | 1.11 |

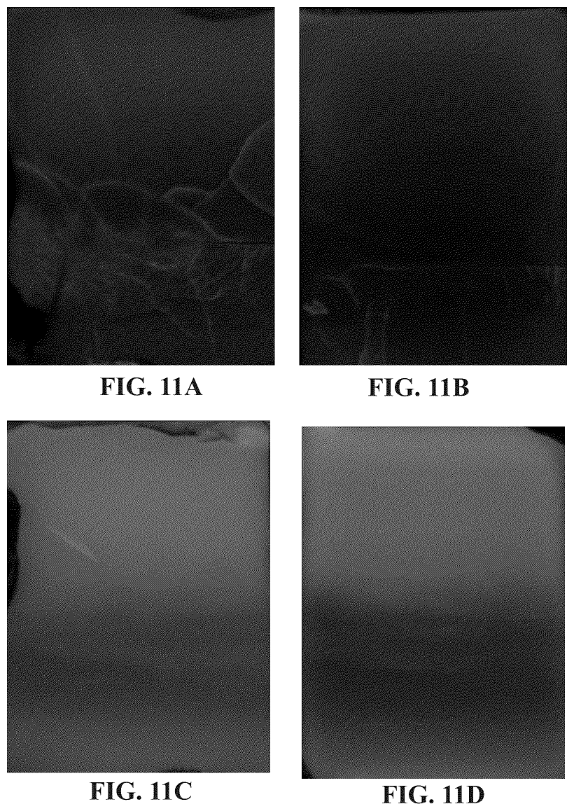

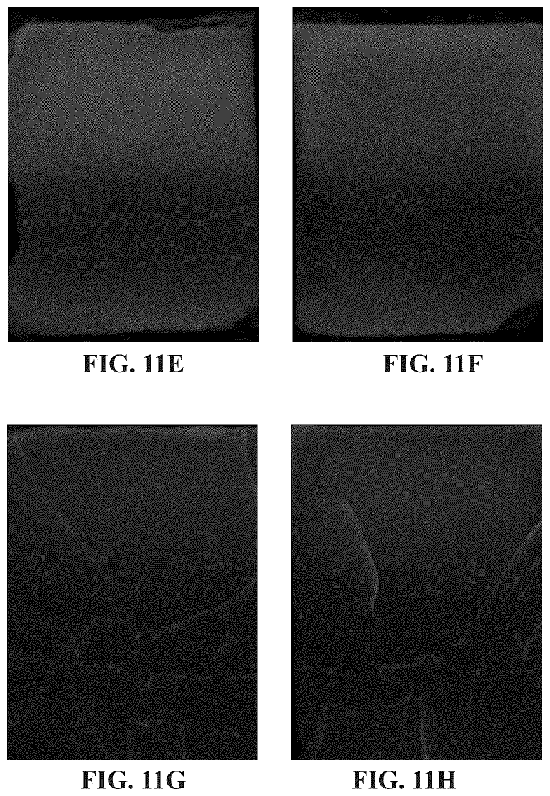

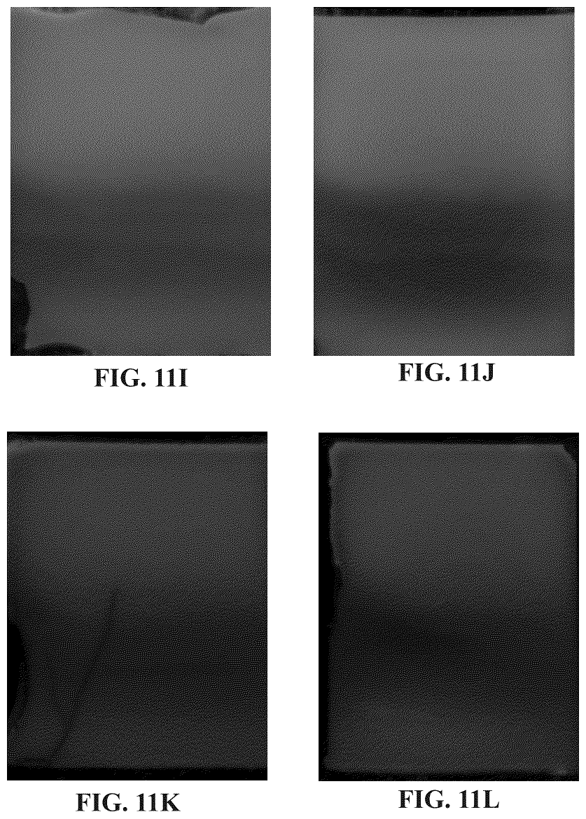

Moreover, FIGS. 11A-11B are images of the skin (FIG. 11A) and core (FIG. 11B) of a comparator sintered ceramic body (Comparator Article 59) comprising 3 mol % yttria cooled with a controlled furnace cooling rate of 11.7° C./minute to a temperature of 1200° C. exhibiting a CIELAB a* at the core of −1.41; Δb* (skin-core) of 14.67; Ahab (core-skin) of 19.64°; and a ΔC (skin-core) of 15.59; and showing gray-green discoloration. FIGS. 11C-11D are images of the skin (FIG. 11C) and core (FIG. 11D) of a comparator sintered ceramic body (Comparator Article 61) comprising 8 mol % yttria cooled with a controlled furnace cooling rate of 11.7° C./minute to a temperature of 1200° C. exhibiting a CIELAB a* at the core of −1.4; Δb* (skin-core) of 6.50; Ahab (core-skin) of 0.96°; and a ΔC (skin-core) of 6.48; and showing gray-green discoloration. FIGS. 11E-11F are images of the skin (FIG. 11E) and core (FIG. 11F) of a comparator sintered ceramic body (Comparator Article 63) comprising 5 mol % yttria (achieved via a mixture of 3 mol % and 8 mol % yttria in the precursor slurry) cooled with a controlled furnace cooling rate of 11.7° C./minute to a temperature of 1200° C. exhibiting a CIELAB a* at the core of −2.27; Δb* (skin-core) of 10.49; Ahab (core-skin) of 10.58°; and a ΔC (skin-core) of 10.4; and showing gray-green discoloration.

FIGS. 11G-11H are images of the skin (FIG. 11G) and core (FIG. 11H) of a sintered ceramic body (Article 60) comprising 3 mol % yttria and 0.72 wt. % Fe₂O₃ cooled with a controlled furnace cooling rate of 1° C./minute to a temperature of 900° C. exhibiting a core CIELAB a* of 9.49; Δb (skin-core) of 1.26; Δh (core-skin) of 1.73°; and a ΔC (skin-core) of 1.65; and showing no gray-green discoloration. FIGS. 11I-11J are images of the skin (FIG. 11I) and core (FIG. 11J) of a sintered ceramic body (Article 62) comprising 8 mol % yttria and 0.72 wt. % Fe₂O₃ cooled with a controlled furnace cooling rate of 1° C./minute to a temperature of 900° C. exhibiting a core CIELAB a* of 0.28; Δb (skin-core) of 6.98; Δh (core-skin) of 4.11°; and a ΔC (skin-core) of 7.1; and showing low gray-green discoloration. FIGS. 11K-11L are images of the skin (FIG. 11K) and core (FIG. 11L) of a sintered ceramic body (Article 64) comprising 5 mol % yttria and 0.72 wt. % Fe₂O₃ cooled with a controlled furnace cooling rate of 1° C./minute to a temperature of 900° C. exhibiting a core CIELAB a* of 5.57; Δb (skin-core) of 2.51; Δh (core-skin) of 3.18°; and a ΔC (skin-core) of 2.95; and showing low gray-green discoloration.

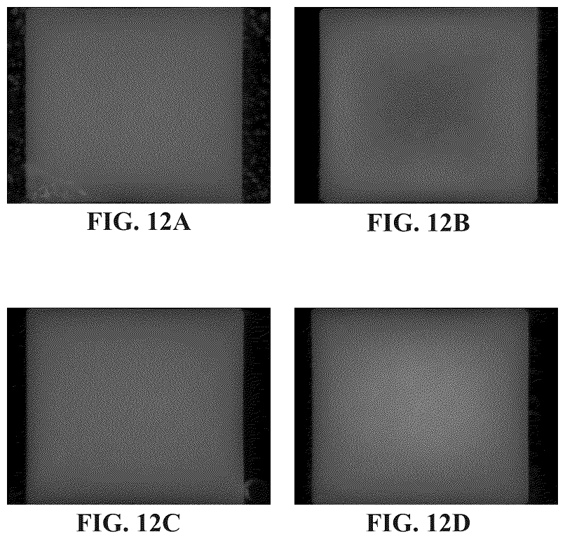

FIGS. 12A-12B are images of the skin (FIG. 12A) and core (FIG. 12B) of a comparator sintered body (Comparator Article 75) comprising 4 mol % yttria and 0.2 wt. % Fe₂O₃ cut to smaller dimensions and cooled with a controlled furnace cooling rate of 11.7° C./minute to a temperature of 1200° C. exhibiting a CIELAB a* at the core of −2.25; Δb* (skin-core) of 15.71; Ahab (core-skin) of 12.02°; and a ΔC (skin-core) of 15.53; and showing gray-green discoloration. FIGS. 12C-12D are images of the skin (FIG. 12C) and core (FIG. 12D) of a sintered ceramic body (Article 76) comprising 4 mol % yttria and 0.2 wt. % Fe₂O₃ cut to smaller dimensions and cooled with a controlled furnace cooling rate of 1° C./minute to a temperature of 900° C. exhibiting a CIELAB a* at the core of 3.55; Δb* (skin-core) of 3.32; Ahab (core-skin) of 2.02; and a ΔC (skin-core) of 3.5; and showing no gray-green discoloration.

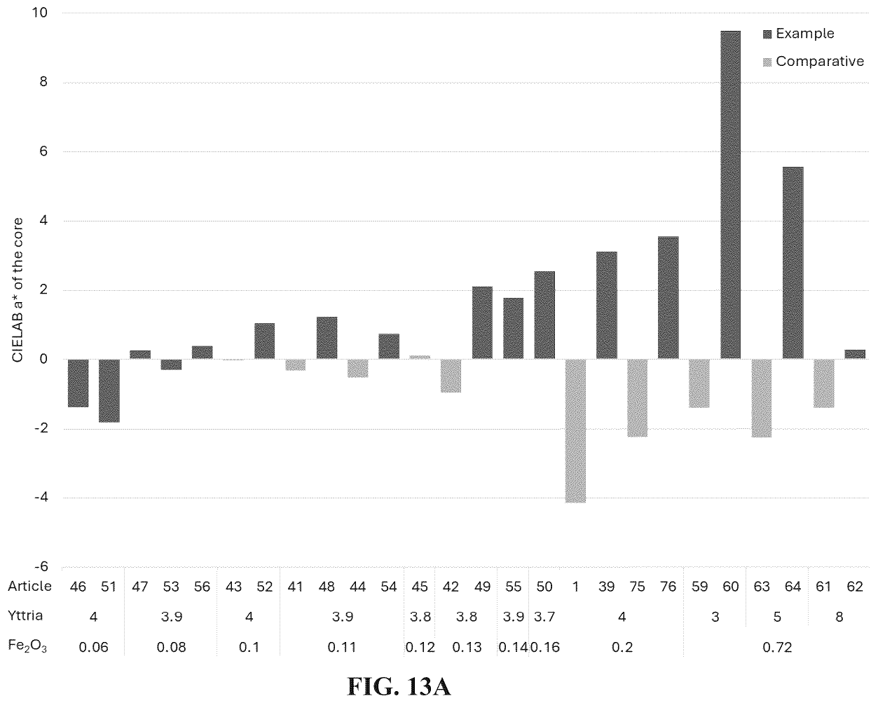

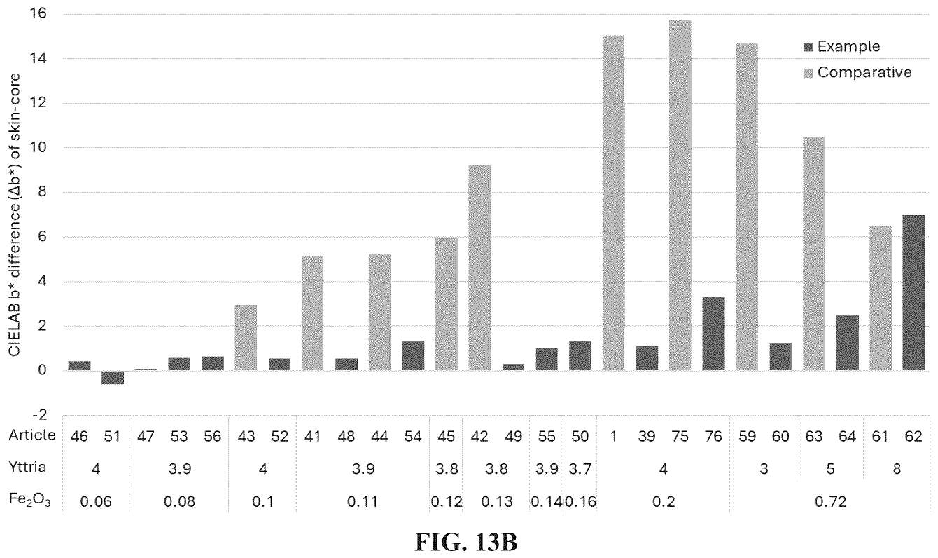

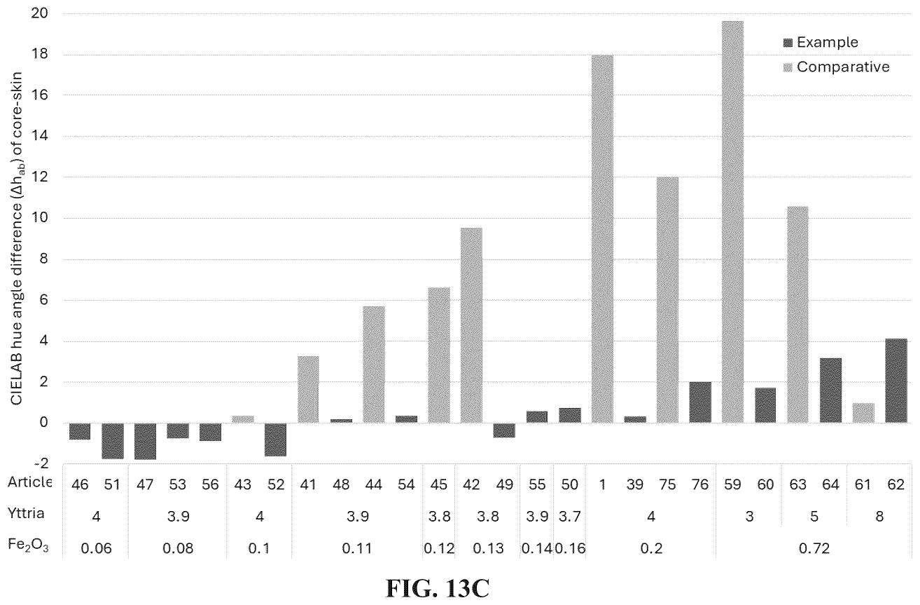

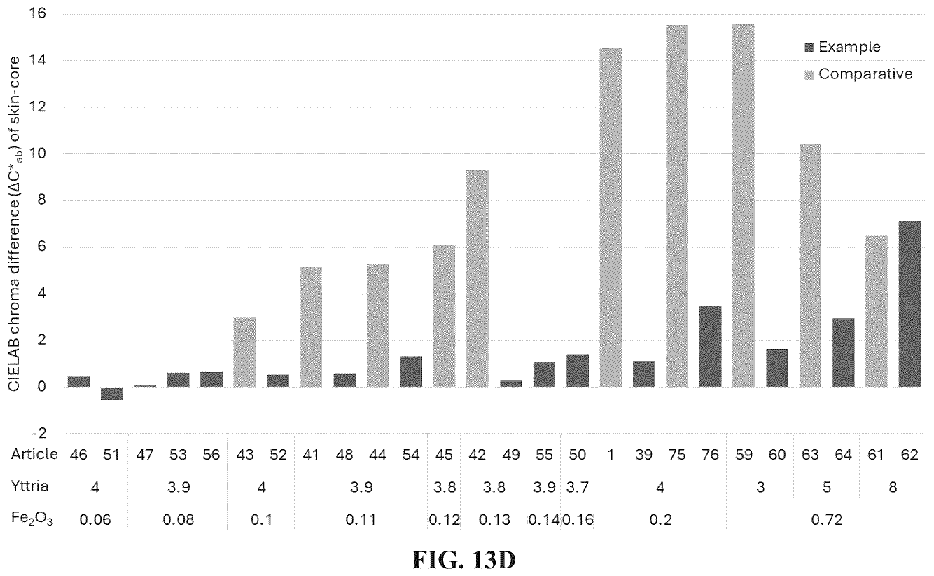

FIGS. 13A-13D are bar graphs comparing the CIELAB a* of the core (FIG. 13A), CIELAB Δb* of skin-core (FIG. 13B), CIELAB hue angle difference (Δh_{ab}) of core-skin (FIG. 13C), CIELAB chroma difference (ΔC*_{ab}) of skin-core (FIG. 13D) of sintered ceramic bodies with a controlled furnace cooling rate of 1° C./minute to a temperature of 900° C. of Article 46 (0.06 wt. % Fe₂O₃, 4 mol % yttria), Article 51 (0.06 wt. % Fe₂O₃, 4 mol % yttria), Article 47 (0.08 wt. % Fe₂O₃, 3.9 mol % yttria), Article 53 (0.08 wt. % Fe₂O₃, 3.9 mol % yttria), Article 56 (0.08 wt. % Fe₂O₃, 3.9 mol % yttria), Article 52 (0.1 wt. % Fe₂O₃, 4 mol % yttria), Article 48 (0.11 wt. % Fe₂O₃, 3.9 mol % yttria), Article 54 (0.11 wt. % Fe₂O₃, 3.9 mol % yttria), Article 49 (0.13 wt. % Fe₂O₃, 3.8 mol % yttria), Article 55 (0.14 wt. % Fe₂O₃, 3.9 mol % yttria), Article 50 (0.16 wt. % Fe₂O₃, 3.7 mol % yttria), Article 39 (0.2 wt. % Fe₂O₃, 4 mol % yttria), Article 76 (0.2 wt. % Fe₂O₃, 4 mol % yttria), Article 60 (0.72 wt. % Fe₂O₃, 3 mol % yttria), Article 64 (0.72 wt. % Fe₂O₃, 5 mol % yttria), Article 62 (0.72 wt. % Fe₂O₃, 8 mol % yttria), versus comparator articles comprising a controlled furnace cooling rate of 11.7° C. to a temperature of 1200° C. of Comparator Article 43 (0.1 wt. % Fe₂O₃, 4 mol % yttria), Comparator Article 41 (0.11 wt. % Fe₂O₃, 3.9 mol % yttria), Comparator Article 44 (0.11 wt. % Fe₂O₃, 3.9 mol % yttria), Comparator Article 45 (0.12 wt. % Fe₂O₃, 3.8 mol % yttria, Comparator Article 42 (0.13 wt. % Fe₂O₃, 3.8 mol % yttria), Comparator Article 1 (0.2 wt. % Fe₂O₃, 4 mol % yttria), Comparator Article 75 (0.2 wt. % Fe₂O₃, 4 mol % yttria), Comparator Article 59 (0.72 wt. % Fe₂O₃, 3 mol % yttria), Comparator Article 63 (0.72 wt. % Fe₂O₃, 5 mol % yttria), Comparator Article 61 (0.72 wt. % Fe₂O₃, 8 mol % yttria).

This example demonstrates lower gray-green discoloration and exhibited desirable CIELAB a* at the core, Δb* (skin-core), Ahab (core-skin), and ΔC (skin-core) values for sintered ceramic bodies cooled with a cooling rate of 1° C./min to a temperature of 900° C. relative to the Comparator Articles cooled with a cooling rate of 11.7° C./min to a temperature of 1200° C. comprising amounts ranging from 0 to 8 mol % yttria, 0 to 0.75 wt. % Fe₂O₃, 0 to 0.55 wt. % Er, and 0 to 0.005 wt. % Co. More specifically, sintered ceramic bodies cooled with a cooling rate of 1° C./min to a temperature of 900° C. exhibited CIELAB b* at the core no more than 8 points below that of the perimeter of the body or any point between (a CIELAB b* difference (Δb*) of the skin minus core being 8 or less); CIELAB hue angle h_{ab} at the core being no more than 5 degrees greater than that of a perimeter of the sintered ceramic body (CIELAB hue angle difference (Δh_{ab}) between the core and perimeter no greater than 5 degrees).

### Example 6

In this example, the sintered bodies were cooled at a cooling rate of 1° C./min to a temperature of 900° C. and were compared to sintered bodies cooled with a cooling rate of 11.7° C./min to a temperature of 1200° C. (Comparator Articles). Table 7 shows the compositions for the sintered ceramic bodies and the corresponding CIELAB b* at the core, CIELAB chroma (C*_{ab}) at the core, CIELAB ΔC*ab (skin-core), core saturation, and CIELAB hue angle difference (Δh_{ab}) of the core-skin values, wherein the skin measurements were taken from the near-edges (approximately less than 0.3 mm deep) of the cross-section scans (i.e., immediate subsurface) for Articles 16-35.

TABLE 7

| | | | | Gray-Green | | | ΔC | | Δh_{ab} |
|---|---|---|---|---|---|---|---|---|---|
| | Yttria | Fe₂O₃ | Co | Core | Core | Core | (skin- | Core | (core- |
| Article | (mol %) | (wt. %) | (wt. %) | Discoloration | b* | C* | core) | Saturation | skin) |
| Comparator | 3 | 0.5 | 0 | Yes | 17.54 | 17.56 | 13.04 | 0.24 | 15.25 |
| Article 20 | | | | | | | | | |
| Comparator | 5.3 | 0.5 | 0 | Yes | 11.97 | 12.17 | 20.64 | 0.17 | 18.11 |
| Article 22 | | | | | | | | | |
| Comparator | 4 | 0.2 | 0 | Yes | 5.52 | 5.52 | 21.08 | 0.09 | −0.27 |
| Article 24 | | | | | | | | | |
| Comparator | 3 | 0.2 | 0 | Yes | 15.39 | 15.49 | 13.65 | 0.20 | 13.31 |
| Article 26 | | | | | | | | | |
| Comparator | 5.3 | 0.2 | 0 | Yes | 14.05 | 14.23 | 10.22 | 0.19 | 1.28 |
| Article 28 | | | | | | | | | |
| Comparator | 5.3 | 0.25 | 0 | Yes | 14.31 | 14.57 | 11.87 | 0.22 | 5.61 |
| Article 30 | | | | | | | | | |
| Comparator | 4 | 0.5 | 0 | Yes | 11.7 | 11.83 | 24.92 | 0.17 | 15.05 |
| Article 32 | | | | | | | | | |
| Comparator | 4 | 0.2 | 0 | Yes | 12.04 | 12.2 | 15.77 | 0.17 | 11.39 |
| Article 34 | | | | | | | | | |
| Comparator | 4 | 0.2 | 0 | Yes | 10.1 | 10.38 | 16.02 | 0.15 | 11.00 |
| Article 16 | | | | | | | | | |
| Comparator | 5.3 | 0.25 | 0 | Yes | 13.31 | 13.48 | 10.41 | 0.18 | 1.55 |
| Article 18 | | | | | | | | | |
| Article 21 | 3 | 0.5 | 0 | No | 22.75 | 22.83 | 10.84 | 0.30 | 11.92 |
| Article 23 | 5.3 | 0.5 | 0 | No | 21.77 | 21.82 | 16.23 | 0.26 | 12.65 |
| Article 25 | 4 | 0.2 | 0 | No | 24.88 | 24.88 | 3.91 | 0.31 | 0.99 |
| Article 27 | 3 | 0.2 | 0 | No | 24.65 | 24.83 | 4.72 | 0.32 | 2.01 |
| Article 29 | 5.3 | 0.2 | 0 | No | 23.81 | 23.86 | 2.51 | 0.29 | −0.26 |
| Article 31 | 5.3 | 0.25 | 0 | No | 24 | 24.03 | 4.17 | 0.30 | 2.26 |
| Article 33 | 4 | 0.5 | 0 | No | 23.49 | 23.5 | 13.95 | 0.31 | 12.96 |
| Article 35 | 4 | 0.2 | 0 | No | 25.11 | 25.17 | 4.5 | 0.32 | 3.75 |
| Article 17 | 4 | 0.2 | 0 | No | 25.92 | 25.94 | 5.64 | 0.34 | 1.84 |
| Article 19 | 5.3 | 0.25 | 0 | No | 22.78 | 22.83 | 6.96 | 0.28 | 1.95 |

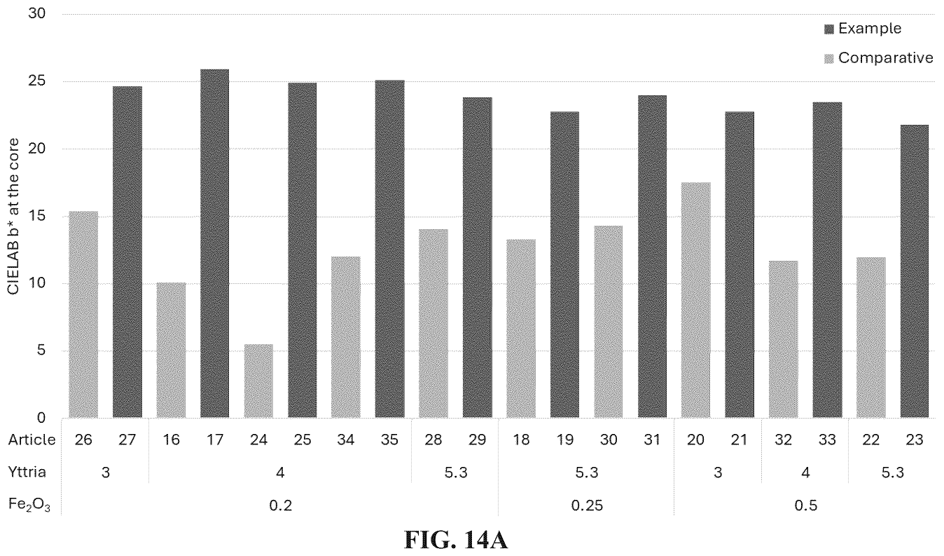

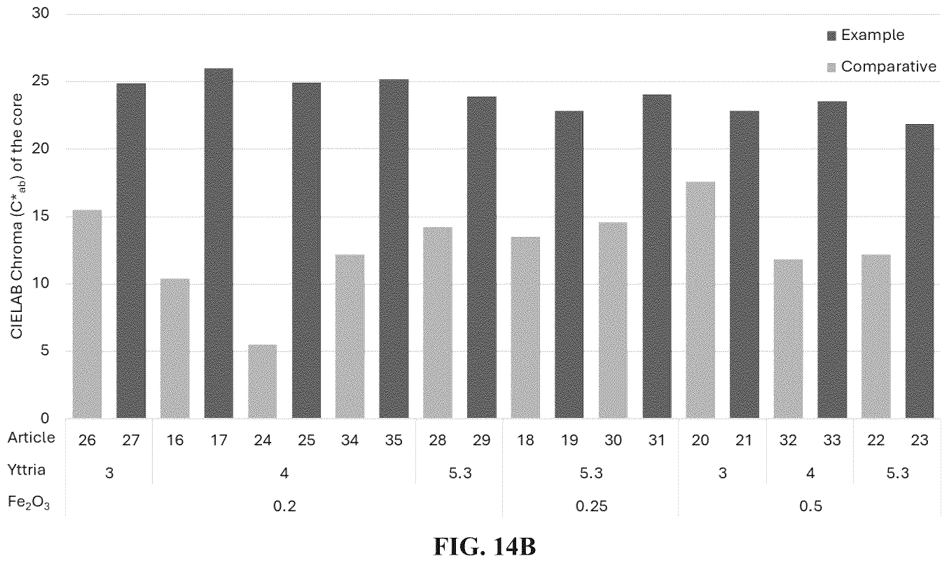

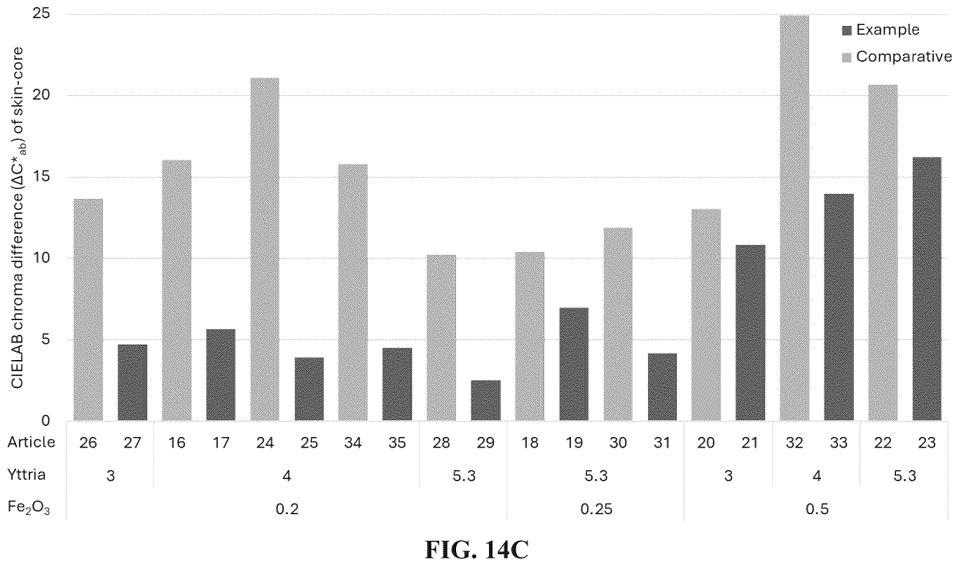

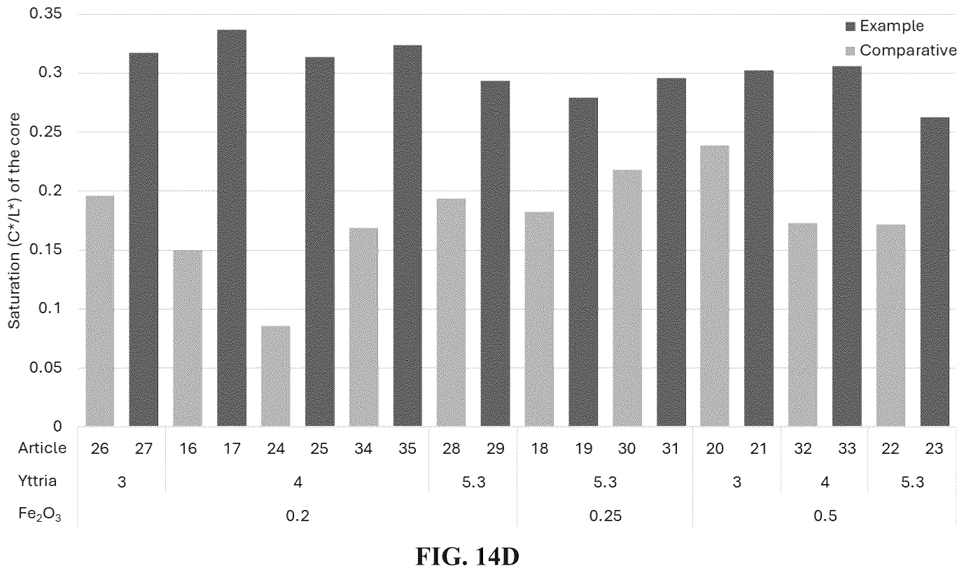

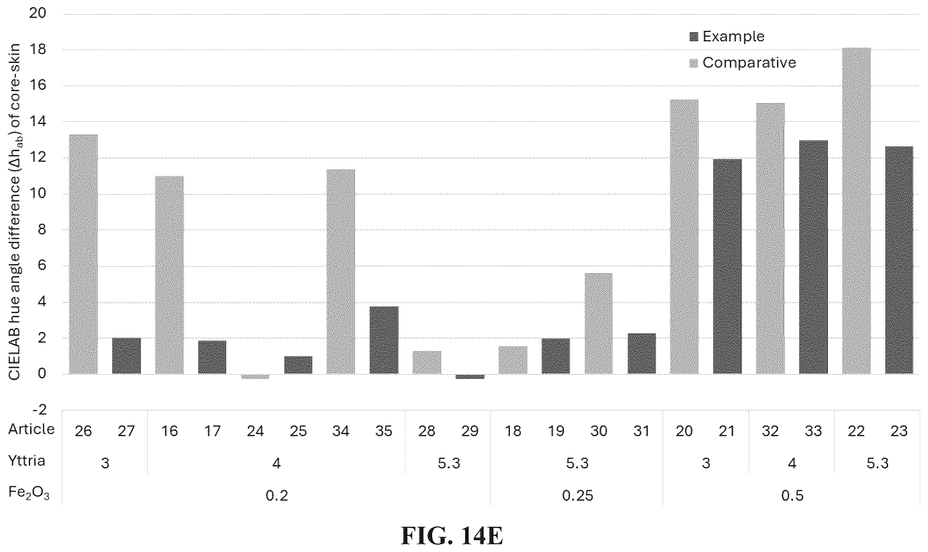

FIGS. 14A-14E are bar graphs showing the CIELAB b* at the core (FIG. 14A), CIELAB chroma (C*_{ab}) of the core (FIG. 14B), CIELAB chroma difference (ΔC*_{ab}) of skin-core (FIG. 14C), saturation (C*/L*) of the core (FIG. 14D), CIELAB hue angle difference (Δh_{ab}) of core-skin (FIG. 14E) of sintered ceramic bodies with a controlled furnace cooling rate of 1° C./minute to a temperature of 900° C. of Article 27 (0.2 wt. % Fe₂O₃, 3 mol % yttria), Article 17 (0.2 wt. % Fe₂O₃, 4 mol % yttria), Article 25 (0.2 wt. % Fe₂O₃, 4 mol % yttria), Article 35 (0.2 wt. % Fe₂O₃, 4 mol % yttria), Article 29 (0.2 wt. % Fe₂O₃, 5.3 mol % yttria), Article 19 (0.25 wt. % Fe₂O₃, 5.3 mol % yttria), Article 31 (0.25 wt. % Fe₂O₃, 5.3 mol % yttria, Article 21 (0.5 wt. % Fe₂O₃, 3 mol % yttria), Article 33 (0.5 wt. % Fe₂O₃, 4 mol % yttria), Article 23 (0.5 wt. % Fe₂O₃, 5.3 mol % yttria) versus comparator articles comprising a controlled furnace cooling rate of 11.7° C. to a temperature of 1200° C. of Comparator Article 26 (0.2 wt. % Fe₂O₃, 3 mol % yttria), Comparator Article 16 (0.2 wt. % Fe₂O₃, 4 mol % yttria), Comparator Article 24 (0.2 wt. % Fe₂O₃, 4 mol % yttria), Comparator Article 34 (0.2 wt. % Fe₂O₃, 4 mol % yttria), Comparator Article 28 (0.2 wt. % Fe₂O₃, 5.3 mol % yttria), Comparator Article 18 (0.25 wt. % Fe₂O₃, 5.3 mol % yttria), Comparator Article 20 (0.5 wt. % Fe₂O₃, 3 mol % yttria), Comparator Article 32 (0.5 wt. % Fe₂O₃, 4 mol % yttria), Comparator Article 22 (0.5 wt. % Fe₂O₃, 5.3 mol % yttria).

This example demonstrates lower gray-green discoloration and exhibited desirable CIELAB b* at the core, CIELAB chroma (C*_{ab}) at the core, CIELAB chroma difference (ΔC*_{ab}) of skin-core, saturation (C*/L*) at the core, CIELAB hue angle difference (Δh_{ab}) of the core-skin values for sintered ceramic bodies cooled with a cooling rate of 1° C./min to a temperature of 900° C. relative to the Comparator Articles cooled with a cooling rate of 11.7° C./min to a temperature of 1200° C. comprising amounts ranging from 3 to 5.3 mol % yttria, 0.20 to 0.50 wt. % Fe₂O₃, and 0 to 0.001 wt. % Co. More specifically, sintered ceramic bodies cooled with a cooling rate of 1° C./min to a temperature of 900° C. exhibited CIELAB b* value of 20 greater at the core, CIELAB chroma (C*_{ab}) value of 20 or greater at the core, CIELAB chroma difference (ΔC*_{ab}) between a perimeter and the core of no greater than 16, saturation (ratio of chroma over lightness; C*ab/L*) of greater than 0.25 to 0.35 at the core, CIELAB hue angle difference (Δh_{ab}) of between the core and the perimeter no greater than 4 degrees (CIELAB hue angle (h_{ab}) at the core no more than 4 degrees greater than that of a perimeter of the sintered body).

### Example 7

In this example, the color uniformity of the sintered ceramic blocks was investigated using different concentrations of manganese. Rectangular ceramic blocks were prepared by pressing non-colored and pre-colored powders containing varying manganese content ranging from greater than 0 ppm to 13 ppm, based on the total weight of the sintered ceramic. The pressed blocks were sintered and subjected to different controlled furnace cooling rates: a cooling rate of 11.7° C./minute from a peak temperature of 1550° C. to 1200° C. and a cooling rate of 1° C./min from a peak temperature of 1550° C. to 900° C. as shown in Table 8.

TABLE 8

| | | | | Elapsed | |
|---|---|---|---|---|---|
| | | Temperature | Time | Time | Ramp |
| Name | Step | (° C.) | (min) | (min) | (° C./min) |
| BEP-1 | 1 | 25 | 120 | 0 | 9.8 |
| BEP-1 | 2 | 1200 | 240 | 120 | 0 |
| BEP-1 | 3 | 1200 | 500 | 360 | 0.5 |
| BEP-1 | 4 | 1450 | 1 | 860 | −50 |
| BEP-1 | 5 | 1400 | 240 | 861 | 0 |
| BEP-1 | 6 | 1400 | 75 | 1101 | 2 |
| BEP-1 | 7 | 1550 | 240 | 1176 | 0 |
| BEP-1 | 8 | 1550 | 30 | 1416 | −11.7 |
| BEP-1 | 9 | 1200 | 70 | 1446 | −14.9 |
| BEP-1 | 10 | 155 | −121 | 1516 | 0 |
| BEP-14 | 1 | 25 | 120 | 0 | 7.3 |
| BEP-14 | 2 | 900 | 300 | 120 | 1 |
| BEP-14 | 3 | 1200 | 240 | 420 | 0 |
| BEP-14 | 4 | 1200 | 500 | 660 | 0.5 |
| BEP-14 | 5 | 1450 | 1 | 1160 | −50 |
| BEP-14 | 6 | 1400 | 240 | 1161 | 0 |
| BEP-14 | 7 | 1400 | 75 | 1401 | 2 |
| BEP-14 | 8 | 1550 | 240 | 1476 | 0 |
| BEP-14 | 9 | 1550 | 650 | 1716 | −1 |
| BEP-14 | 10 | 900 | 60 | 2366 | −10.8 |
| BEP-14 | 11 | 250 | 0 | 2426 | 0 |

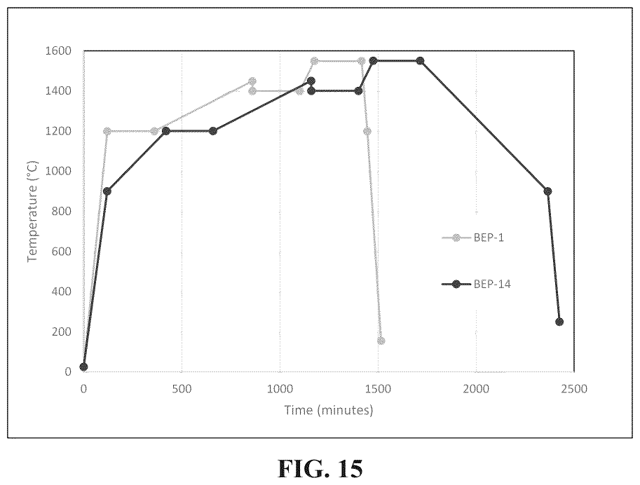

FIG. 15 is a line graph (temperature v. time) showing the temperature profiles of a sintered rectangular block comprising yttria (2.7 mol %), Fe₂O₃ (0.06 wt. %), Mn (3 ppm), and Er (0.25 wt. %) and a sintered rectangular block comprising yttria (2.8 mol %), Fe₂O₃ (0.11 wt. %), Mn (13 ppm), and Er (0.12 wt. %) cooled at a controlled furnace cooling rate of 1° C./minute to a temperature of 900° C. versus a controlled furnace cooling rate of 11.7° C. to a temperature of 1200° C.

Table 9 shown below shows the cool-to temperatures and cooling rates of the temperature profiles depicted in FIG. 15 for Comparator Article 77 comprising yttria (2.7 mol %), Fe₂O₃ (0.06 wt. %), Mn (3 ppm), and Er (0.25 wt. %) and Comparator Article 79 comprising yttria (2.8 mol %), Fe₂O₃ (0.11 wt. %), Mn (13 ppm), and Er (0.12 wt. %); and Article 78 comprising yttria (2.7 mol %), Fe₂O₃ (0.06 wt. %), Mn (3 ppm), and Er (0.25 wt. %) and Article 80 comprising yttria (2.8 mol %), Fe₂O₃ (0.11 wt. %), Mn (13 ppm), and Er (0.12 wt. %).

TABLE 9

| Article | Cool to Temp (° C.) | Cooling Rate (° C./min) |
|---|---|---|
| Comparator Article 77 | 1200 | 11.7 |
| Comparator Article 79 | 1200 | 11.7 |
| Article 78 | 900 | 1 |
| Article 80 | 900 | 1 |

Color uniformity was evaluated by measuring the color difference (AE) between the skin and core regions of each ceramic block using CIELAB measurements. Table 10 below shows the properties of resulting sintered ceramic bodies and of the comparator articles produced using the cool-to temperature and cooling rate shown above in Table 9.

TABLE 10

| | | | | | Gray-Green | | Δb* | Δh_{ab} | ΔC |
|---|---|---|---|---|---|---|---|---|---|
| | Y | Fe₂O₃ | Mn | Er | Core | Core | (skin- | (core- | (skin- |
| Article | (mol %) | (wt. %) | (ppm) | (wt. %) | Discoloration | a* | core) | skin) | core) |
| Comparator | 2.7 | 0.06 | 3 | 0.25 | No | 1.69 | −0.75 | −0.34 | −0.76 |
| Article 77 | | | | | | | | | |
| Comparator | 2.8 | 0.11 | 13 | 0.12 | Slight | 0.9 | 1.25 | 3.71 | 1.36 |
| Article 79 | | | | | | | | | |
| Article 78 | 2.7 | 0.06 | 3 | 0.25 | No | 2.5 | −0.40 | −0.12 | −0.41 |
| Article 80 | 2.8 | 0.11 | 13 | 0.12 | No | 3.32 | 0.92 | 0.83 | 0.98 |

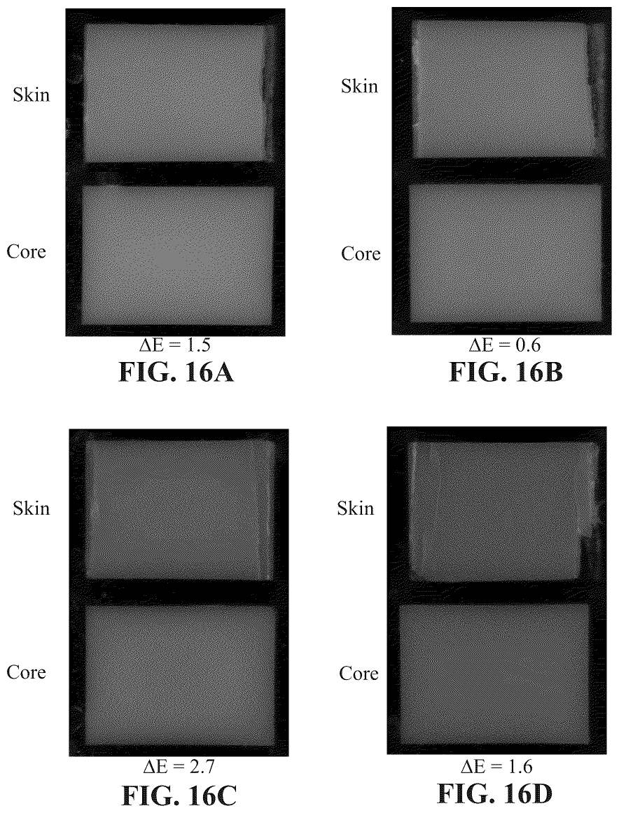

FIG. 16A is an image of Comparator Article 77 produced with a controlled furnace cooling rate of 11.7° C./minute to a temperature of 1200° C. FIG. 16B is an image of the skin and core Article 78 produced with a controlled furnace cooling rate of 1° C./minute to a temperature of 900° C. FIG. 16C is an image of the skin and core of Comparator Article 79 produced with a controlled furnace cooling rate of 11.7° C./minute to a temperature of 1200° C. FIG. 16D is image of the skin and core of Article 80 produced with a controlled furnace cooling rate of 1° C./minute to a temperature of 900° C.

Articles 78 and 80, cooled at a slower controlled furnace cooling rate of 1° C./min to 900° C., exhibited desirable color uniformity, with Article 78 (FIG. 16B) achieving the lowest ΔE (0.6), indicating reduced perceivable color differences between skin and core regions compared to the Comparator Articles, which were cooled at the faster rate. Accordingly, this example demonstrates that controlled cooling to lower temperatures in the presence of manganese content produced more desirable color uniformity in sintered ceramic materials.

In view of the many possible aspects to which the principles of the present disclosure may be applied, it should be recognized that the illustrated aspects are only preferred examples of the of the present disclosure and should not be taken as limiting the scope of the present disclosure. Rather, the scope of the disclosure is defined by the following claims. We therefore claim as our invention all that comes within the scope and spirit of these claims.

We claim:

1. A material, comprising:
a sintered ceramic comprising iron (III) oxide (Fe₂O₃) and yttria-stabilized zirconia;
a distance from a cross-sectional center comprising a core to a perimeter portion of the sintered ceramic ranging from 4 millimeters to 15 millimeters; and
(i) a CIELAB a* at the core greater than −2, (ii) a first CIELAB b* at the core of less than or equal to 8 points below a second CIELAB b* at the perimeter portion of the sintered ceramic, (iii) a first CIELAB hue angle (h_{ab}) at the core of less than or equal to 5 degrees greater than a second CIELAB hue angle (h_{ab}) at the perimeter portion; (iv) or any combination of (i), (ii), and/or (iii).

2. The material of claim 1, wherein the sintered ceramic comprises amounts of iron (III) oxide (Fe₂O₃) ranging from greater than 0 wt. % to 0.8 wt. %, based on the total weight of the sintered ceramic.

3. The material of claim 1, wherein the sintered ceramic has a yttria content ranging from greater than 0 mol % to 8 mol %.

4. The material of claim 1, further comprising a coloring agent selected from erbium, cobalt, manganese, or any combination thereof.

5. The material of claim 4, wherein the coloring agent comprises erbium ranging from greater than 0 wt. % to 0.55 wt. %, based on the total weight of the sintered ceramic.

6. The material of claim 4, wherein the coloring agent comprises cobalt ranging from greater than 0 wt. % to 0.005 wt. %, based on the total weight of the sintered ceramic.

7. The material of claim 4, wherein the coloring agent comprises manganese ranging from greater than 0 wt. % to 0.0013 wt. %, based on the total weight of the sintered ceramic.

8. The material of claim 1, wherein the sintered ceramic comprises amounts of iron (III) oxide (Fe₂O₃) ranging from greater than 0 wt. % to 0.20 wt. %, based on the total weight of the sintered ceramic and the first CIELAB b* at the core of less than or equal to 5 points below the second CIELAB b* at the perimeter portion of the sintered ceramic.

9. The material of claim 8, comprising a first CIELAB chroma (C*_{ab}) at the core of less than or equal to 5 points below a second CIELAB chroma (C*_{ab}) at the perimeter portion of the sintered ceramic.

10. The material of claim 1, wherein the sintered ceramic comprises amounts of iron (III) oxide (Fe₂O₃) ranging from greater than 0.10 wt. % to 0.75 wt. %, based on the total weight of the sintered ceramic, and a CIELAB a* at the core greater than 0.

11. The material of claim 1, wherein the sintered ceramic comprises a flexural strength of greater than or equal to 800 MPa.

12. The material of claim 1, wherein the sintered ceramic body is formed by:
introducing the iron (III) oxide (Fe₂O₃) via: (i) a pre-integrated yttria-stabilized zirconia powder to form a mixture; (ii) spraying a solution comprising an iron-containing salt in a solvent onto a non-shaded pressable yttria-stabilized zirconia powder to form a mixture; or (iii) mixing the resulting mixture of (ii) with non-shaded yttria-stabilized powder;
pressing or casting the resulting mixture into a green block;
bisque the green block resulting in a bisqued body; and
sintering the bisqued body resulting in the sintered ceramic body.

13. The material of claim 1, wherein the sintered ceramic body is formed by:
introducing the iron (III) oxide (Fe₂O₃) via: (i) a pre-integrated yttria-stabilized zirconia powder to form a mixture or (ii) mixing an iron (III) oxide (Fe₂O₃) powder with yttria-stabilized zirconia powder to form a mixture;
dispersing the mixture in a slurry comprising water and a dispersing agent;
slip-casting the resulting mixture in a bisqued-body; and
sintering the bisqued body resulting in the sintered ceramic body.

14. A material, comprising:
a sintered ceramic comprising iron (III) oxide (Fe₂O₃) and yttria-stabilized zirconia;
a minimum distance from a cross-sectional center comprising a core to a perimeter portion of the sintered ceramic ranging from 5 millimeters to 15 millimeters; and
(i) a first CIELAB b* value at the core of at least 20 or greater; (ii) a CIELAB chroma (C*_{ab}) value of 20 or greater at the core; (iii) a CIELAB chroma difference (ΔC*_{ab}) between the perimeter portion and the core ranging from greater than 0 to 16; (iv) a saturation (C*ab/L*) at the core ranging from 0.25 to 0.35; or (v) or any combination of (i), (ii), (iii) and/or (iv).

15. The material of claim 14, wherein the ceramic body is stabilized by 3 mol % yttria to 5.3 mol % yttria.

16. The material of claim 14, wherein the sintered ceramic body comprises from 0.20 wt. % to 0.50 wt. % iron (III) oxide (Fe₂O₃), based on the total weight of the sintered ceramic body.

17. The material of claim 14, wherein the sintered ceramic body further comprises greater than 0 wt. % cobalt to 0.001 wt. % cobalt, based on the total weight of the sintered ceramic body.

18. The material of claim 14, wherein the sintered ceramic body comprises from 0.20 wt. % to 0.25 wt. % iron (III) oxide (Fe₂O₃), based on the total weight of the sintered ceramic body, and the first CIELAB (C*_{ab}) at the core ranging from greater than 0 points to 10 points below a second CIELAB (C*_{ab}) at the perimeter portion.

19. A method for making a sintered ceramic body, comprising:
introducing an iron-containing, yttria-stabilized zirconia ceramic material into a furnace;
heating the ceramic material in the furnace to a furnace temperature ranging from 1200° C. to 1700° C. for at least 5 minutes; and
cooling the ceramic material at a controlled furnace cooling rate ranging from greater than 0° C./minute to 3° C./minute to a temperature ranging from 800° C. to 1200° C.

20. The method of claim 19, wherein the iron-containing, yttria-stabilized zirconia ceramic material comprises (i) a green state; (ii) a bisqued or partially sintered state; or (iii) a sintered ceramic material.
